(19) United States
(12) Patent Application Publication
(10) Pub. No.: US 2026/0259247 A1
(43) Pub. Date: Sep. 3, 2026

(54) VIBRATION COMPONENT MEASURING DEVICE, KELVIN PROBE FORCE SPECTROMETER, VIBRATION COMPONENT MEASURING METHOD, AND INTERFACE STATE DENSITY MEASURING METHOD

(71) Applicant: OSAKA UNIVERSITY, Osaka (JP)

(72) Inventor: Yasuhiro SUGAWARA, Osaka (JP)

(21) Appl. No.: 18/878,794

(22) PCT Filed: Jun. 7, 2023
(86) PCT No.: PCT/JP2023/021102

§ 371 Date: Dec. 24, 2024

(30) Foreign Application Priority Data
Jun. 30, 2022 (JP) 2022-106292

(51) Int. Cl. G01Q 60/32; G01Q 60/30

(52) U.S. Cl. CPC G01Q 60/32; G01Q 60/30

(57) ABSTRACT

In order to more efficiently measure a change in a varying component of a vibration section and to more efficiently calculate an interface state density of a sample, a vibration component measuring device (2) includes: a vibration section (4); a vibration control section (10) configured to cause the vibration section to vibrate on the basis of a first AC signal; a signal applying section (14, 48) configured to apply, between the vibration section and the sample, a DC signal and at least one selected from the group consisting of a second AC signal and a reference AC signal; and a measuring section (42, 44) configured to measure the varying component of vibration of the vibration section. The measuring section measures a change in the varying component relative to a change in voltage value of the DC signal.

### TECHNICAL FIELD

The present disclosure relates to a technique for measuring a varying component of vibration of a vibration section or a technique for measuring an interface state density by the technique for measuring the varying component, and also relates to a device for realizing the method, in particular, to a spectrometer including the device.

### BACKGROUND ART

In recent years, in order to improve semiconductor device performance, there has been a demand for visualizing an interface charge at, for example, an interface between a semiconductor layer and another layer. Non-Patent Literature 1 discloses a method for measuring an interface state density of a sample having a MOS structure in which a metal film, an oxide film, and a semiconductor film which are fixed are layered, by applying high- and low-frequency AC bias voltages to the sample.

### CITATION LIST

### Non-Patent Literature

### [Non-patent Literature 1]

R. Castagne and A. Vapaelle. Description of the SiO2 Si interface properties by means of very low frequency MOS capacitance measurements. Surf. Sci. 28 (1971), pp. 157-193

### SUMMARY OF INVENTION

### Technical Problem

With use of the method disclosed in the above document is limited to use in measurement of an interface state density in a macro region in which metal electrode regions are averaged, and with use of the method, it is difficult to measure a nanoscale interface state density. On this account, there has been a demand for a device or method capable of measuring behavior of a sample more efficiently or at a higher definition in a case where a signal applied to the sample has a low frequency and in a case where a signal applied to the sample has a high frequency.

### Solution to Problem

In order to solve the above problem, a vibration component measuring device in accordance with an aspect of the present disclosure includes: a vibration section; a first AC signal generator configured to generate a first AC signal; a second AC signal generator configured to generate a second AC signal having a frequency which is higher than a frequency of the first AC signal and which differs from an integral multiple of the frequency of the first AC signal; a reference AC signal generator configured to generate a reference AC signal having a frequency which is lower than the frequency of the first AC signal; a DC signal generator configured to generate a DC signal; a vibration control section configured to cause the vibration section to vibrate on the basis of the first AC signal; a signal applying section configured to apply, between the vibration section and a sample, the DC signal and the second AC signal and/or the reference AC signal; and a measuring section configured to measure a varying component of vibration of the vibration section, the varying component being varied by an interaction between the vibration section and the sample.

In an aspect of the vibration component measuring device, the DC signal generator is configured to generate at least two DC signals including a first DC signal and a second DC signal having a voltage which is different from a voltage of the first DC signal, the measuring section measuring a change in the varying component relative to a change in voltage value between the first DC signal and the second DC signal, from the varying component in a case where the DC signal is set to the first DC signal and the varying component in a case where the DC signal is set to the second DC signal.

In another aspect of the vibration component measuring device, the measuring section measures a first derivative value, with respect to a voltage of the DC signal, of the varying component.

In another aspect of the vibration component measuring device, the measuring section measures a second derivative value, with respect to a voltage of the DC signal, of the varying component.

In order to solve the above problem, a method in accordance with an aspect of the present disclosure for measuring a vibration component, includes the steps of: generating a first AC signal for causing a vibration section to vibrate; generating a second AC signal having a frequency which is higher than a frequency of the first AC signal and which differs from an integral multiple of the frequency of the first AC signal; generating a reference AC signal having a frequency which is lower than the frequency of the first AC signal; generating a DC signal; and measuring a varying component of vibration of the vibration section by applying, between the vibration section and a sample, the DC signal and at least one selected from the group consisting of the second AC signal and the reference AC signal and causing the vibration section to vibrate on the basis of the first AC signal, the varying component of the vibration of the vibration section being varied by an interaction between the vibration section and the sample.

In an aspect of the method for measuring a vibration component, at least two DC signals including a first DC signal and a second DC signal having a different voltage from the first DC signal are generated, and in the step of measuring the varying component, a change in the varying component relative to a change in voltage value between the first DC signal and the second DC signal is measured from the varying component in a case where the DC signal is set to the first DC signal and the varying component in a case where the DC signal is set to the second DC signal.

In another aspect of the method for measuring a vibration component measuring device, in the step of measuring the varying component, a first derivative value, with respect to a voltage of the DC signal, of the varying component is measured.

In another aspect of the method for measuring a vibration component measuring device, in the step of measuring the varying component, a second derivative value, with respect to a voltage of the DC signal, of the varying component is measured.

### Advantageous Effects of Invention

An aspect of the present disclosure makes it possible to measure a change of a varying component more efficiently or at higher resolution. Thus, it is possible to measure, from a difference in the varying component, a change in behavior of a sample more efficiently in a case where a signal applied to the sample has a low frequency and in a case where a signal applied to the sample has a high frequency.

### BRIEF DESCRIPTION OF DRAWINGS

a FIG. 1 is a block diagram for illustrating configuration of a vibration component measuring device in accordance with Embodiment 1 and an operation of the vibration component measuring device.

FIG. 2 is a graph showing a strength of a signal which an optical sensor in accordance with Embodiment 1 receives, at each frequency of the signal.

FIG. 3 is a block diagram for illustrating respective configurations of a first phase locked loop circuit and an automatic gain control in accordance with Embodiment 1.

FIG. 4 is a block diagram for illustrating a configuration of a second phase locked loop circuit in accordance with Embodiment 1.

FIG. 5 is a graph showing the strength of a signal which is inputted to an actual frequency lock-in amplifier in accordance with Embodiment 1, at each frequency of the signal.

FIG. 6 is a graph showing the strength of a signal that is outputted from a first amplitude modulator in accordance with Embodiment 1, at each frequency of the signal.

FIG. 7 is a block diagram for illustrating another example of the operation of the vibration component measuring device in accordance with Embodiment 1.

FIG. 8 is a graph showing another example of the strength of a signal which the optical sensor in accordance with Embodiment 1 receives, at each frequency of the signal.

FIG. 9 shows band diagrams for illustrating how a band in a bulk of a sample bends depending on states of a surface of the sample.

FIG. 10 shows band diagrams for illustrating how band bending in a bulk of a sample varies due to variation of an external electric field.

FIG. 11 is a graph that shows a cutoff frequency for each difference between a Fermi level of the bulk of the sample and a Fermi level of the surface of the sample, the cutoff frequency being a frequency which a signal applied to an external electrode has and at which variation of the band bending in the bulk of the sample no longer occurs.

FIG. 12 is an equivalent circuit diagram showing capacitances formed between a sample and an electrode, in a case where a frequency of a signal applied to an external electrode is less than the cutoff frequency.

FIG. 13 is an equivalent circuit diagram showing capacitances formed between a sample and an electrode, in a case where a frequency of a signal applied to an external electrode is not less than the cutoff frequency.

FIG. 14 is an example of a graph showing the strength of a signal which is outputted from an actual frequency lock-in amplifier in accordance with Embodiment 1, at each value of DC voltage.

FIG. 15 includes a band diagram and a schematic sectional side view of the vicinity of a sample, which illustrate a state in which an accumulation layer is formed, by an external electric field, in the vicinity of an interface of a sample.

FIG. 16 includes a band diagram and a schematic sectional side view of the vicinity of a sample, which illustrate a state in which a depletion layer is formed, by an external electric field, in the vicinity of an interface of a sample.

FIG. 17 includes a band diagram and a schematic sectional side view of the vicinity of a sample, which illustrate a state in which an inversion layer is formed, by an external electric field, in the vicinity of an interface of a sample.

FIG. 18 is a block diagram for illustrating a configuration of a vibration component measuring device in accordance with Embodiment 2 and an operation of the vibration component measuring device.

FIG. 19 is a graph showing a strength of a signal which an optical sensor in accordance with Embodiment 2 receives, at each frequency of the signal.

FIG. 20 is a graph showing the strength of a signal which is inputted to an actual frequency lock-in amplifier and a double frequency lock-in amplifier in accordance with Embodiment 2, at each frequency of the signal.

FIG. 21 is a block diagram for illustrating another example of the operation of the vibration component measuring device in accordance with Embodiment 2.

FIG. 22 is a block diagram for illustrating a configuration of a vibration component measuring device in accordance with Embodiment 3 and an operation of the vibration component measuring device.

FIG. 23 is a block diagram for illustrating a configuration of a vibration component measuring device in accordance with Embodiment 4 and an operation of the vibration component measuring device.

FIG. 24 is a block diagram for illustrating a configuration of a vibration component measuring device in accordance with Embodiment 5 and an operation of the vibration component measuring device.

FIG. 25 is a block diagram for illustrating a configuration of a vibration component measuring device in accordance with Embodiment 6 and an operation of the vibration component measuring device.

FIG. 26 is a block diagram for illustrating a configuration of a vibration component measuring device in accordance with Embodiment 7 and an operation of the vibration component measuring device.

FIG. 27 is a block diagram for illustrating a configuration of a vibration component measuring device in accordance with Embodiment 8 and an operation of the vibration component measuring device.

FIG. 28 is a block diagram for illustrating a configuration of a vibration component measuring device in accordance with Embodiment 9 and an operation of the vibration component measuring device.

### DESCRIPTION OF EMBODIMENTS

### Embodiment 1

The following description will discuss an embodiment according to the present disclosure, with reference to drawings. Note that the drawings which are used in the following description are schematic views and do not show exact dimensional ratios of members in the drawings.

FIG. 1 is a block diagram for illustrating a configuration of a vibration component measuring device 2 in accordance with the present embodiment, and an operation of the vibration component measuring device 2. Note that the vibration component measuring device 2 in accordance with the present embodiment includes a first switche S1 and a second switche S2, which will be described later. In the present embodiment, first, the following description will discuss, as an example, an operation of the vibration component measuring device 2 in a state in which the first switch S1 is closed while the second switch S2 is open. This operation is referred to as a first operation.

### <Cantilever Probe and Stage>

The vibration component measuring device 2 in accordance with the present embodiment includes a cantilever probe 4 as a vibration section. The cantilever probe 4 includes a cantilever part 6 and a probe part 8 that is formed at an end portion of the cantilever part 6. The vibration component measuring device 2 in accordance with the present embodiment is a device for measuring a vibration component of the cantilever probe 4. The vibration component measuring device 2 makes such measurement by bringing the probe part 8 close to a sample X while vibrating the cantilever part 6 of the cantilever probe 4.

In the present embodiment, the sample X may contain, for example, a semiconductor or a semiconductor having a surface where an oxide film or the like is formed. In other words, the sample X may have a plurality of layers and at least one interface between the plurality of layers. The present embodiment will discuss an example in which an interface state density at a surface or interface of the semiconductor of the sample X is measured through measurement, by the vibration component measuring device 2, of a vibration component of the cantilever probe 4 described above.

Note that, in the present embodiment, the following description will discuss, as an example, a technique according to which while the sample X and the cantilever probe 4 are kept in a non-contact state at all times, the vibration component of the cantilever probe 4 is measured. However, an embodiment of the present invention is not limited to such a method. For example, the vibration component of the cantilever probe 4 may be measured by using a technique that is generally referred to as a tapping mode. In this technique, the sample X and the cantilever probe 4 come into contact with each other intermittently due to the vibration of the cantilever probe 4. However, from the viewpoint of preventing damage to the sample X from occurring, the vibration component of the cantilever probe 4 may be measured while the sample X and the cantilever probe 4 are kept in a non-contact state at all times.

The vibration component measuring device 2 includes a probe control section 10 as a vibration control section which vibrates the cantilever probe 4 at a vibration frequency corresponding to a frequency of an applied voltage. Specifically, in a case where no interaction is present between the cantilever probe 4 and the sample and further the cantilever probe 4 has a resonant frequency which is a frequency f₁, a first AC signal which has the frequency f₁ is inputted to the probe control section 10.

The vibration component measuring device 2 includes a stage 12 for supporting the sample X, and a stage electrode 14 for applying voltage to the sample X. For example, as illustrated in FIG. 1, the stage electrode 14 and the sample X are made to be electrically conductive, and the cantilever probe 4 is grounded. In this configuration, when voltage is applied to the stage electrode 14, it is possible to apply, between the cantilever probe 4 and the sample X, a voltage equal to the voltage which is applied to the stage electrode 14.

Note that though details will be described later, a second AC signal is applied to the stage electrode 14 in the present embodiment. The second AC signal has a frequency that is obtained by adding a frequency which is twice the frequency f₁ described above and a frequency fₘ that is lower than the frequency f₁. Though details will be described later, the signal applied to the stage electrode 14 includes a signal in which a direct-current (DC) signal which has a voltage V_{dc} is superimposed on the above-described second AC signal.

### <Detection of Vibration Component>

In the present embodiment, the vibration component of the cantilever probe 4 is detected by using, for example, a so-called optical lever method with use of a light source 16 and an optical sensor 18 which are provided in the vibration component measuring device 2.

The light source 16 is, for example, a laser diode, and irradiates the cantilever probe 4 with light. Then, the optical sensor 18 is irradiated with the light with which the cantilever probe 4 is irradiated and which is reflected by the cantilever probe 4.

It should be noted here that the optical sensor 18 is an optical position sensor, and may be, for example, a quadrant photodiode. The vibration of the cantilever probe 4 varies a position where the optical sensor 18 is irradiated with the light reflected by the cantilever probe 4. Therefore, the optical sensor 18 can determine the vibration component of the cantilever probe 4 from a varying component at a position where the optical sensor 18 has received the light reflected by the cantilever probe 4.

For example, the optical sensor 18 calculates, for each vibration frequency of the cantilever probe 4, a vibration strength of the cantilever probe 4 on the basis of a periodic variation of the position where the optical sensor 18 receives the light and an intensity of the light which is received at each position. Further, the optical sensor 18 outputs a signal in accordance with a detection result. In the present embodiment, the signal which is outputted by the optical sensor 18 is a signal obtained by replacing, with a signal strength for each frequency, the vibration strength of the cantilever probe 4 for each vibration frequency of the cantilever probe 4, the vibration strength having been calculated by the optical sensor 18.

### <Signal Outputted by Optical Sensor>

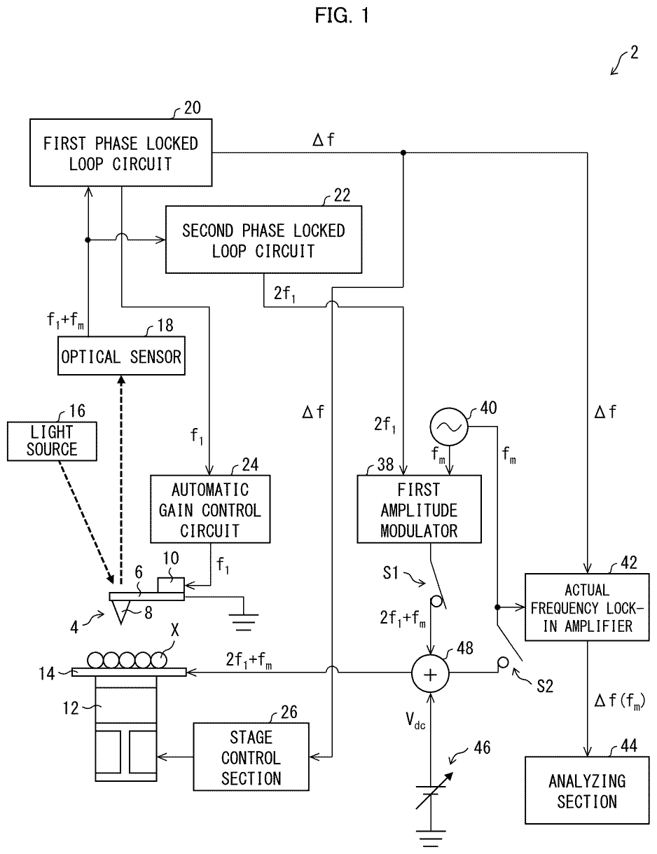

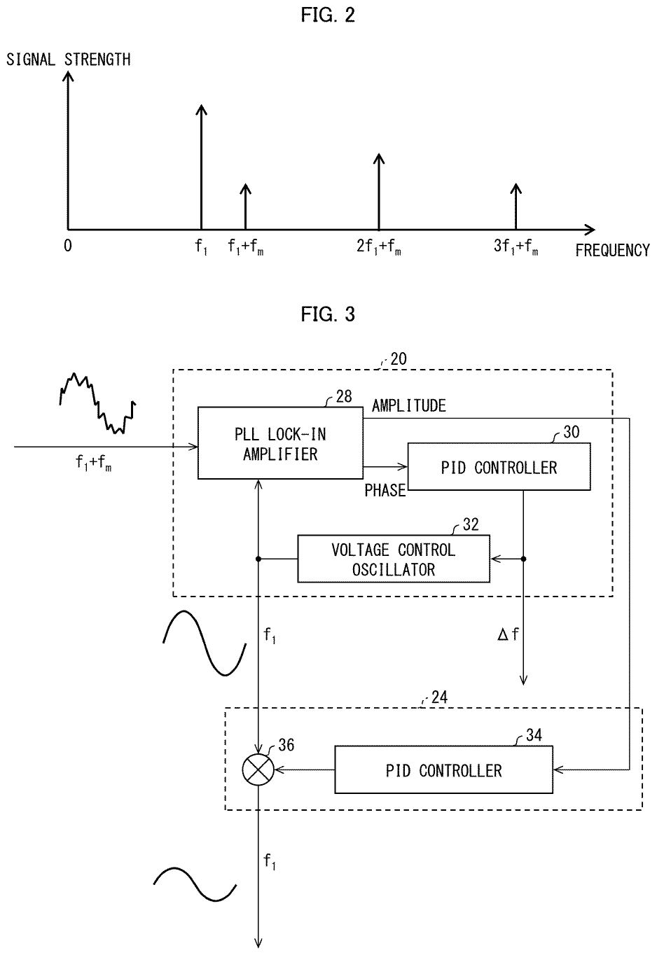

FIG. 2 is a graph which shows an example of a signal which is outputted by the optical sensor 18. In FIG. 2, the horizontal axis represents the frequency of the signal which is outputted by the optical sensor 18, and the vertical axis represents the strength of the signal which is outputted by the optical sensor 18.

The signal which is outputted by the optical sensor 18 includes, as a main component, a component that has the frequency f₁ equivalent to the vibration frequency of the cantilever probe 4.

It should be noted here that the vibration component measuring device 2 applies, between the cantilever probe 4 and the sample X, the second AC signal having a frequency 2f₁+fₘ. For this reason, electrostatic force that acts on the cantilever probe 4 as the electrostatic interaction between the cantilever probe 4 and the sample X varies with the frequency. The vibration of the cantilever probe 4 thus has a component at a vibration frequency 2f₁+fₘ. Therefore, the signal which is outputted by the optical sensor 18 has a component at the frequency 2f₁+fₘ, as shown in FIG. 2.

Further, since the cantilever probe 4 vibrates at a vibration frequency f₁, the vibration of the cantilever probe 4 has, at a vibration frequency f₁+fₘ and a vibration frequency 3f₁+fₘ, side bands of a modulated component. Therefore, the signal which is outputted by the optical sensor 18 also has components at a frequency f₁+fₘ and a frequency 3f₁+fₘ as shown in FIG. 2.

Further, in a case where there is a difference in charge density due to, for example, local charge bias, at an interface of any one of samples X that faces the probe part 8 of the cantilever probe 4, the electrostatic interaction between the cantilever probe 4 and the sample X changes due to the charge density. Such a change in the electrostatic interaction between the cantilever probe 4 and the sample X due to the charge density shifts, by Δf, resonant frequency of the cantilever probe 4. Furthermore, the varying component of the vibration of the cantilever probe 4 is observed as changes in amplitude R and phase θ in a side band of the modulated component of the signal which has been outputted by the optical sensor 18.

In other words, in the present embodiment, it is possible to measure the change in the electrostatic interaction between the cantilever probe 4 and the sample X by observing the changes in the amplitude R and the phase θ in the side band of the modulated component of the vibration of the cantilever probe 4. It is possible to measure, from the change in the electrostatic interaction, the capacitance virtually formed between the cantilever probe 4 and the sample X.

Note that a signal in the above-described side band of the modulated component of the vibration of the cantilever probe 4 may be a signal in the case of an upper side band or in the case of a lower side band. In other words, fₘ may take either a positive value or a negative value.

Note that, in a case where the frequency of the second AC signal is increased with respect to the vibration frequency of the cantilever probe 4, the side band of the modulated component of the vibration of the cantilever probe 4 has a drastically decreased strength. Accordingly, in a case where the frequency of the second AC signal is simply increased, it may be difficult to observe the side band because the side band is buried in white noise.

However, in a case where the frequency of the second AC signal is increased to a frequency of approximately twice the vibration frequency of the cantilever probe 4, there is an increase in the strength of the side band of the modulated component of the vibration of the cantilever probe 4. Accordingly, in a case where the frequency of the second AC signal is increased to a frequency approximately twice the vibration frequency of the cantilever probe 4, measurement can be more easily carried out since the strength of the side band increases.

In the present embodiment, the frequency of the second AC signal is a frequency obtained by adding a frequency fₘ that is lower than the frequency f₁ to a frequency that is twice the frequency f₁ equivalent to the vibration frequency of the cantilever probe 4. Therefore, the frequency of the second AC signal becomes a frequency approximately twice the vibration frequency of the cantilever probe 4, so that it becomes possible to make the modulated component of the vibration of the cantilever probe 4 sufficiently strong.

However, in the present embodiment, the frequency of the second AC signal is not limited to this configuration, and only need to be higher than first AC signal and differ from an integral multiple of the frequency of the first AC signal. As a result, in a case where a signal in which the second AC signal is superimposed is applied to a sample X, at least a side band of the modulated component of the vibration of the cantilever probe 4 can be obtained.

### <First Phase Locked Loop Circuit and Automatic Gain Control Circuit>

The signal which has been outputted from the optical sensor 18 is inputted to a first phase locked loop circuit 20 and a second phase locked loop circuit 22, which are provided as phase locked loop circuits (PLL circuits) in the vibration component measuring device 2. The first phase locked loop circuit 20 further generates a signal on the basis of the signal thus inputted, and inputs the signal thus generated to an automatic gain control circuit 24 and a stage control section 26, which are provided in the vibration component measuring device 2.

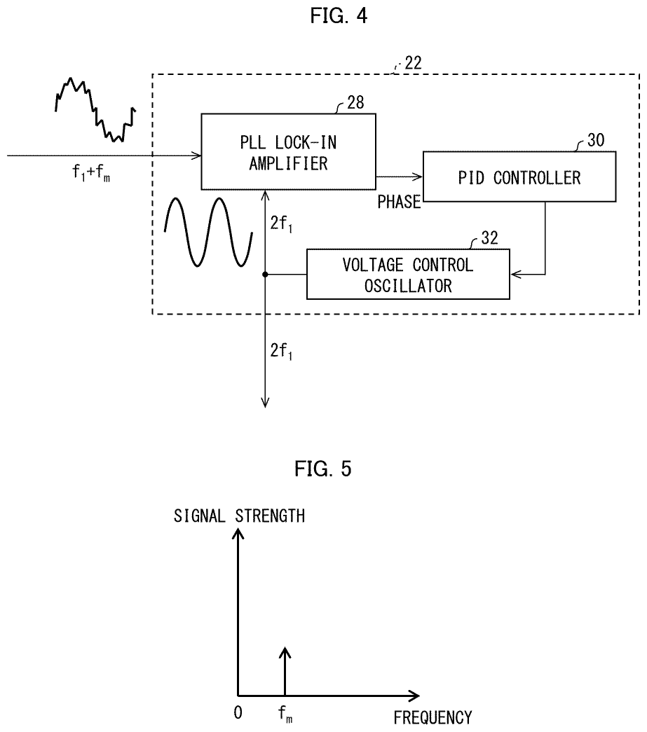

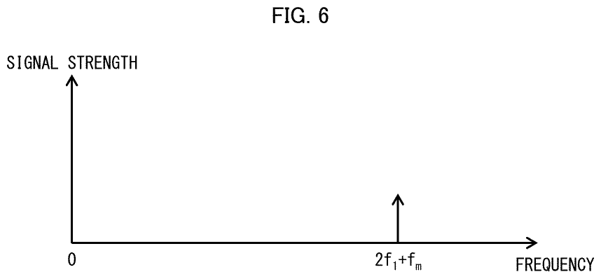

The following description will discuss in detail a configuration and an operation of each of the first phase locked loop circuit 20 and the second phase locked loop circuit 22, with reference to FIGS. 3 and 4.

FIG. 3 is a block diagram for illustrating the configuration and the operation of the first phase locked loop circuit 20. Note that with reference to FIG. 3, the following description will also discuss the automatic gain control circuit 24. To the automatic gain control circuit 24, some of signals which are outputted from the first phase locked loop circuit 20 illustrated in FIG. 1 are inputted.

The first phase locked loop circuit 20 includes a PLL lock-in amplifier 28, a PID controller 30, and a voltage controlled oscillator 32. The automatic gain control circuit 24 includes a PID controller 34, and a multiplier 36.

The signal which has been inputted to the first phase locked loop circuit 20 from the optical sensor 18 is inputted to the PLL lock-in amplifier 28. The PLL lock-in amplifier 28 is used as a phase comparator. The phase comparator makes a comparison of phases between the signal which has been inputted from the optical sensor 18 and a criterion signal which is inputted from the voltage controlled oscillator 32 that will be described later in detail. In the present embodiment, the PLL lock-in amplifier 28 outputs respective signals obtained by replacing, with voltages, a phase difference and an amplitude difference between the signal from the optical sensor 18 and the criterion signal.

Specifically, the PLL lock-in amplifier 28 includes a multiplier for multiplying the two signals which have been inputted, and a low-pass filter for extracting only a low-frequency component out of the signals which have been generated by the multiplier. Therefore, in the PLL lock-in amplifier 28, though the multiplier outputs (i) a high frequency wave that has a frequency equivalent to the sum of frequencies of the two signals which have been inputted and (ii) a low frequency wave which has a frequency equivalent to a difference between the frequencies of the two signals, only the low frequency wave is extracted by the low-pass filter.

The signal outputted from the PLL lock-in amplifier 28 has been obtained by replacing, with a voltage, the phase difference between the signal from the optical sensor 18 and the criterion signal, and is then inputted to the voltage controlled oscillator 32 via the PID controller 30. The voltage controlled oscillator 32 outputs a signal which has a certain frequency, on the basis of the signal which has been outputted from the PID controller 30.

The voltage controlled oscillator 32 may be, for example, a voltage controlled crystal oscillator (VCXO), which includes a crystal oscillator as a resonator. In the present embodiment, the voltage controlled oscillator 32 generates a signal which has the frequency f₁ on the basis of the signal that has been inputted from the PID controller 30. In other words, the resonator of the voltage controlled oscillator 32 oscillates at the frequency f₁. Therefore, the first phase locked loop circuit 20 functions as an oscillator whose frequency multiplication ratio is 1. The oscillator generates, from the signal that has been inputted, the signal having the frequency f₁, that is, the first AC signal.

The PID controller 30 gives feedback to the voltage controlled oscillator 32 so that a phase of the first AC signal which is outputted by the voltage controlled oscillator 32 is shifted by π/2 from a frequency f₁ component of the signal which is inputted to the first phase locked loop circuit 20 from the optical sensor 18.

Therefore, among the signals which are outputted from the PLL lock-in amplifier 28, the signal obtained by replacing, with a voltage, the phase difference between the signal from the optical sensor 18 and the first AC signal has a frequency equivalent to a difference between respective frequencies of the signal from the optical sensor 18 and the first AC signal. Further, among the signals which are outputted from the PLL lock-in amplifier 28, a signal obtained by replacing, with a voltage, an amplitude difference between the signal from the optical sensor 18 and the first AC signal has an amplitude equivalent to a difference between respective amplitudes of the signal from the optical sensor 18 and the first AC signal.

Among the signals which are outputted from the PLL lock-in amplifier 28, the signal obtained by replacing, with a voltage, the amplitude difference between the signal from the optical sensor 18 and the first AC signal is inputted to the multiplier 36 via the PID controller 34 of the automatic gain control circuit 24. Further, the first AC signal which has been outputted from the voltage controlled oscillator 32 is inputted to the multiplier 36, and multiplied by the signal from the PID controller 34.

The PID controller 34 thus gives feedback on gain of the first AC signal which is outputted from the voltage controlled oscillator 32, on the basis of the signal from the PLL lock-in amplifier 28. As a result, the amplitude of the first AC signal which is outputted from the automatic gain control circuit 24 is kept substantially constant.

As illustrated in FIG. 1, the first AC signal which has been outputted from the automatic gain control circuit 24 is applied to the probe control section 10. Since the feedback on the amplitude of the first AC signal is given by the automatic gain control circuit 24, the first AC signal having the amplitude that is substantially constant is inputted to the probe control section 10. Therefore, the first phase locked loop circuit 20 and the automatic gain control circuit 24 function as a first AC signal generator that generates the first AC signal.

The first phase locked loop circuit 20 thus detects the vibration frequency of the cantilever probe 4, and generates the first AC signal on the basis of the vibration frequency. Accordingly, it is not necessary to separately prepare a device that generates the first AC signal. The first phase locked loop circuit 20 can continuously generate the first AC signal after the cantilever probe 4 is once oscillated.

### <Second Phase Locked Loop Circuit>

FIG. 4 is a block diagram for illustrating the configuration and the operation of the second phase locked loop circuit 22. The second phase locked loop circuit 22 includes a PLL lock-in amplifier 28, a PID controller 30 and a voltage controlled oscillator 32 as in the first phase locked loop circuit 20.

A signal which has been inputted to the second phase locked loop circuit 22 from the optical sensor 18 is inputted to the PLL lock-in amplifier 28. Then, the PLL lock-in amplifier 28 outputs respective signals obtained by replacing, with voltages, a phase difference and an amplitude difference between the signal from the optical sensor 18 and the criterion signal.

The PID controller 30 which is provided in the second phase locked loop circuit 22 has the same function as the PID controller 30 which is provided in the first phase locked loop circuit 20. In other words, the PID controller 30 outputs, from the signal which has been inputted from the PLL lock-in amplifier 28, a signal which has a frequency equivalent to a difference between a frequency of the signal from the optical sensor 18 and a frequency of the criterion signal.

It should be noted here that the voltage controlled oscillator 32 which is provided in the second phase locked loop circuit 22 has a frequency multiplication ratio that is set to 2, as compared with the voltage controlled oscillator 32 which is provided in the first phase locked loop circuit 20. Therefore, the voltage controlled oscillator 32 which is provided in the second phase locked loop circuit 22 generates a signal which has the frequency 2f₁ on the basis of the signal that has been inputted from the PID controller 30. In other words, the resonator of the voltage controlled oscillator 32 oscillates at the frequency 2f₁. Therefore, the second phase locked loop circuit 22 functions as an oscillator whose frequency multiplication ratio is 2. The oscillator generates, from the signal that has been inputted, the signal having the frequency 2f₁, in other words, a frequency twice the frequency of the first AC signal.

<Signals Outputted from Phase Locked Loop Circuits>

As illustrated in FIG. 2, the signal which is outputted from the optical sensor 18 includes a component at the frequency f₁ and a component at the frequency f₁+fₘ. Accordingly, the signal that has the component at the frequency f₁ and the signal that has the component at the frequency f₁+fₘ are inputted to the PLL lock-in amplifier 28 of the first phase locked loop circuit 20.

Therefore, the signal which has been inputted to the PLL lock-in amplifier 28 is compared with the first AC signal which has the frequency f₁. The PID controller 30 of the first phase locked loop circuit 20 outputs a signal which has the component at the frequency fₘ in addition to the DC component. Accordingly, the first phase locked loop circuit 20 outputs a measurement signal that includes, as illustrated in FIG. 5, the varying component of the vibration of the cantilever probe 4 and the component at the frequency fₘ.

From the above description, the vibration component measuring device 2 includes, as the measurement signal generator that generates the measurement signal, the light source 16, the optical sensor 18, and the first phase locked loop circuit 20.

The signal which is outputted from the optical sensor 18 includes the component at the frequency 2f₁+fₘ and the component at the frequency 3f₁+fₘ. However, in the present embodiment, the PLL lock-in amplifier 28 outputs, via the low-pass filter, only a signal which has a component at a frequency in the vicinity of the frequency of the DC component, as described above. In addition, the PLL lock-in amplifier 28 in accordance with the present embodiment is also configured to output, via the low-pass filter, only a signal which has a component at a frequency that is not higher than approximately the frequency fₘ.

### <Feedback to Stage>

Among measurement signals which have been outputted from the first phase locked loop circuit 20, the signal which has the DC component is inputted to the stage control section 26. The stage control section 26 controls a position of the stage 12 on the basis of the measurement signal. This allows the stage control section 26 to control a position of the probe part 8 above the sample X and a distance between the sample X and the probe part 8.

For example, in the present embodiment, the distance between the sample X and the probe part 8 is controlled by the stage control section 26. This allows the stage control section 26 to give feedback so that among frequencies of the measurement signals, the value of a frequency shift Δf can be constant, the frequency shift Δf being equivalent to a vibration frequency shift of the cantilever probe 4.

In a case where the distance between the sample X and the probe part 8 is constant while the cantilever probe 4 is not vibrating, the vibration frequency shift Δf is constant. Therefore, while the vibration frequency shift Δf is kept constant, the probe part 8 performs scanning on the sample X and a position on the stage 12 is sequentially recorded, so that the vibration component measuring device 2 can measure a shape of an interface of the sample X.

Note that the stage control section 26 may include a filter for filtering the measurement signals which have been outputted from the first phase locked loop circuit 20. Further, in a case where the sample X has a plurality of interfaces, the stage control section 26 may adjust, by controlling a distance between the cantilever probe 4 and the stage 12, a target interface that is to be measured by the vibration component measuring device 2.

### <Amplitude Modulator>

In the present embodiment, the vibration component measuring device 2 generates the above-described second AC signal, with use of an amplitude modulator. The vibration component measuring device 2 includes a first amplitude modulator 38, as illustrated in FIG. 1. The first amplitude modulator 38 is, for example, a single side band modulator (SSB modulator).

The first amplitude modulator 38 includes, for example, a multiplier, and generates (i) a signal which has a frequency obtained by adding up respective frequencies of two signals that have been inputted, and (ii) a signal which has a frequency obtained by subtracting a frequency of one of the two signals that have been inputted from a frequency of the other one of the two signals. Note that, in the present embodiment, the first amplitude modulator 38 extracts, from the above two signals, only the signal which has a frequency obtained by adding up the respective frequencies of the two signals that have been inputted, and outputs the signal thus extracted.

To the first amplitude modulator 38, a double frequency signal which has a frequency that is twice the frequency f₁ of the first AC signal is inputted. In the present embodiment, the double frequency signal is generated by the second phase locked loop circuit 22 described above.

Further, to the first amplitude modulator 38, a reference AC signal is inputted. This reference AC signal has been outputted from an AC power source 40 that is provided in the vibration component measuring device 2. The AC power source 40 outputs the reference AC signal which has the frequency fₘ. In other words, the vibration component measuring device 2 includes the AC power source 40, as a reference AC signal generator that generates the reference AC signal.

Therefore, the first amplitude modulator 38 generates the second AC signal that has the frequency 2f₁+fₘ, which is obtained by adding up the frequency of the double frequency signal and the frequency of the reference AC signal. This allows the second AC signal to be generated, by the first amplitude modulator 38, from (i) the double frequency signal which has been generated by the second phase locked loop circuit 22 and (ii) the reference AC signal from the AC power source 40. As a result, it is possible to generate the second AC signal in a simple configuration. In other words, the vibration component measuring device 2 includes, as a second AC signal generator that generates the second AC signal, the second phase locked loop circuit 22, the first amplitude modulator 38, and the AC power source 40.

Note that the vibration component measuring device 2 may include, as a double frequency generator, a doubler that doubles the frequency of an inputted signal in place of the second phase locked loop circuit 22. In this case, the first AC signal which is outputted by the first phase locked loop circuit 20 may be inputted to the doubler, and thus the double frequency signal may be generated by the doubler.

### <Measurement of Varying Component>

The vibration component measuring device 2 in accordance with the present embodiment further includes at least one lock-in amplifier to which the measurement signal from the first phase locked loop circuit 20 is inputted as a comparison signal. Specifically, the vibration component measuring device 2 in accordance with the present embodiment includes an actual frequency lock-in amplifier 42. The actual frequency lock-in amplifier 42 may include the same configuration as the PLL lock-in amplifier 28.

In the present embodiment, to the actual frequency lock-in amplifier 42, a signal that includes a component which includes a frequency shift Δf is inputted as the comparison signal. This signal is outputted from the first phase locked loop circuit 20. Further, the reference AC signal which has the frequency fₘ from the AC power source 40 is inputted, as an actual frequency reference signal that has the same frequency as the reference AC signal, to the actual frequency lock-in amplifier 42. In the present embodiment, the actual frequency lock-in amplifier 42 compares, with the reference signal from the AC power source 40, the comparison signal from the first phase locked loop circuit 20. The actual frequency lock-in amplifier 42 thus outputs a signal which includes, as the varying component of the vibration of the cantilever probe 4 that is the vibration section, a modulated component Δf(fₘ) which is a component at the frequency fₘ among components of the frequency shift Δf.

The vibration component measuring device 2 in accordance with the present embodiment further includes an analyzing section 44 to which the signal which includes the modulated component Δf(fₘ) that has been outputted from the actual frequency lock-in amplifier 42 is inputted. The analyzing section 44 measures the modulated component Δf(fₘ). Then, the analyzing section 44 calculates, by a technique that will be described later, electric capacitance between the interface of the sample X and the cantilever probe 4 from the modulated component Δf(fₘ) that has been measured for each voltage V_{dc} of the DC signal which is applied to the sample X.

Therefore, the actual frequency lock-in amplifier 42 and the analyzing section 44 serve as a measuring section that measures the modulated component Δf(fₘ) as the varying component which is a component of vibration of the cantilever probe 4 and which is varied by an interaction between the cantilever probe 4 and the sample X. The measuring section also includes the light source 16, the optical sensor 18, and the first phase locked loop circuit 20. These are for generating a comparison signal that allows the actual frequency lock-in amplifier 42 and the analyzing section 44 to measure the modulated component Δf(fₘ).

The vibration component measuring device 2 in accordance with the present embodiment further includes a DC power source 46, and an adder 48. The DC power source 46 outputs a DC signal which has a voltage V_{dc}. In other words, the DC power source 46 functions as a DC signal generator that generates the DC signal.

The adder 48 superimposes a plurality of signals that have been inputted, and applies a resultant superimposed signal to the stage electrode 14. In the first operation of the vibration component measuring device 2, the second AC signal which has been outputted from the first amplitude modulator 38 is inputted to the adder 48 via the first switch S1. Further, the DC signal from the DC power source 46 is also inputted to the adder 48. Therefore, in the first operation of the vibration component measuring device 2, the adder 48 applies, to the sample X via the stage electrode 14, a signal in which the second AC signal and the DC signal are superimposed on each other. Therefore, the stage electrode 14 and the adder 48 serve as a signal applying section that applies a signal between the cantilever probe 4 and the sample X.

Note that the AC power source 40 is connected to the adder 48 via the second switch S2. However, as illustrated in FIG. 1, in a case where the second switch S2 is open, the reference AC signal from the AC power source 40 is not applied to the adder 48. Therefore, in the first operation of the vibration component measuring device 2, the reference AC signal is not superimposed on the signal which is applied to the stage electrode 14.

The vibration component measuring device 2 measures the modulated component Δf(fₘ), for example, while changing the value of the voltage V_{dc}. The vibration component measuring device 2 at least measures the modulated component Δf(fₘ) in each of (i) a case where the DC signal applied to the sample X is a first DC signal and (ii) a case where the DC signal applied to the sample X is a second DC signal whose value of the voltage V_{dc} is different from that of the first DC signal.

### <Another Operation of Vibration Component Measuring Device>

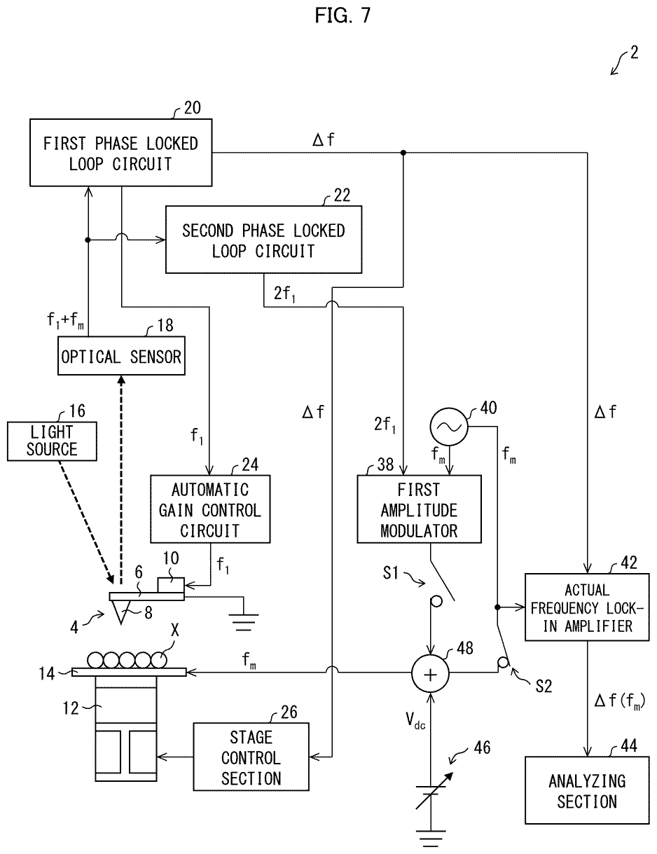

Next, with reference to FIG. 7, the following description will discuss, as a second operation, an operation of the vibration component measuring device 2 in a state in which the first switch S1 is open and the second switch S2 is closed. FIG. 7 is a block diagram for illustrating the second operation of the vibration component measuring device 2 in accordance with the present embodiment.

In the second operation of the vibration component measuring device 2, since the first switch S1 is open, the signal which is outputted by the first amplitude modulator 38 is not applied to the adder 48. On the other hand, in the second operation of the vibration component measuring device 2, since the second switch S2 is closed, the reference AC signal from the AC power source 40 is applied to the adder 48 via the second switch S2. Therefore, the adder 48 applies, to the sample X via the stage electrode 14, a signal in which the reference AC signal and the DC signal having the voltage V_{dc} are superimposed on each other.

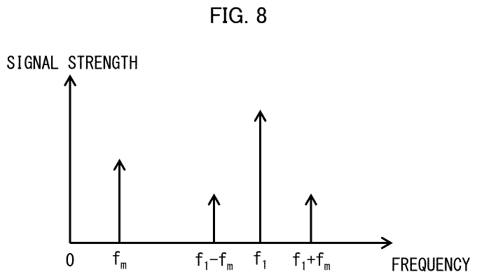

FIG. 8 is a graph which shows an example of a signal which is outputted by the optical sensor 18 in the second operation of the vibration component measuring device 2. In FIG. 8, in the same manner as in FIG. 2, the horizontal axis represents the frequency of the signal which is outputted by the optical sensor 18 and the vertical axis represents the strength of the signal which is outputted by the optical sensor 18.

In the second operation of the vibration component measuring device 2, a reference AC signal having the frequency fₘ is applied between the cantilever probe 4 and the sample X. The vibration of the cantilever probe 4 thus has a component at a vibration frequency fₘ. Therefore, the signal which is outputted by the optical sensor 18 has a component at the frequency fₘ, as illustrated in FIG. 8.

Further, since the cantilever probe 4 vibrates at the vibration frequency f₁, the vibration of the cantilever probe 4 has, at the vibration frequency f₁+fₘ and a vibration frequency f₁−fₘ, side bands of a modulated component. Therefore, the signal which is outputted by the optical sensor 18 also has components at the frequency f₁+fₘ and a frequency f₁−fₘ as shown in FIG. 8.

As illustrated in FIG. 8, in the second operation of the vibration component measuring device 2, as in the first operation, the signal which is outputted from the optical sensor 18 includes a component at the frequency f₁ and a component at the frequency f₁+fₘ. Therefore, the first phase locked loop circuit 20 outputs an AC signal which has the frequency f₁ and which is inputted to the automatic gain control circuit 24, and a measurement signal which includes a component of the frequency shift Δf. Note that in the second operation of the vibration component measuring device 2, the signal from the first amplitude modulator 38 does not contribute to application of the signal to the sample X. Accordingly, the signal from the optical sensor 18 may not be inputted to the second phase locked loop circuit 22.

Therefore, in the second operation of the vibration component measuring device 2, as in the first operation, to the actual frequency lock-in amplifier 42, the signal which includes the component of the frequency shift Δf is inputted as a comparison signal and the reference AC signal is inputted as a reference signal. Accordingly, the actual frequency lock-in amplifier 42 outputs a signal that includes a modulated component Δf(fₘ) which s a component at the frequency fₘ among the components of the frequency shift Δf. Further, the analyzing section 44 calculates, by a technique that will be described later, electric capacitance between the interface of the sample X and the cantilever probe 4 from the modulated component Δf(fₘ) that has been measured for each voltage V_{dc}.

In particular, in the second operation of the vibration component measuring device 2, the signal applied to the sample X has the frequency fₘ that is lower than the frequency 2f₁+fₘ which is a frequency of the signal applied to the sample X in the first operation of the vibration component measuring device 2. The vibration component measuring device 2 measures a difference between the modulated components Δf(fₘ) that are obtained in the first operation and the second operation, respectively. This allows the vibration component measuring device 2 to measure a difference, in electric capacitance between the cantilever probe 4 and the sample X, between a case where the signal applied to the sample has a low frequency and a case where the signal applied to the sample has a high frequency.

### <Band Bending>

Prior to describing a method of calculating the interface state density at an interface of a sample X with use of the vibration component measuring device 2, the following description will discuss bending of a valence band and a conduction band in the vicinity of the interface of the sample X. The bending is caused by an interface charge of the sample X. Note that in the following discussion, an MIS structure is used as a model, and a consideration is made. In this MIS structure, a gap between the cantilever probe 4 and the sample X is assumed as a vacuum gap. Further, a thin film such as an oxide film is assumed to be absent on a semiconductor surface.

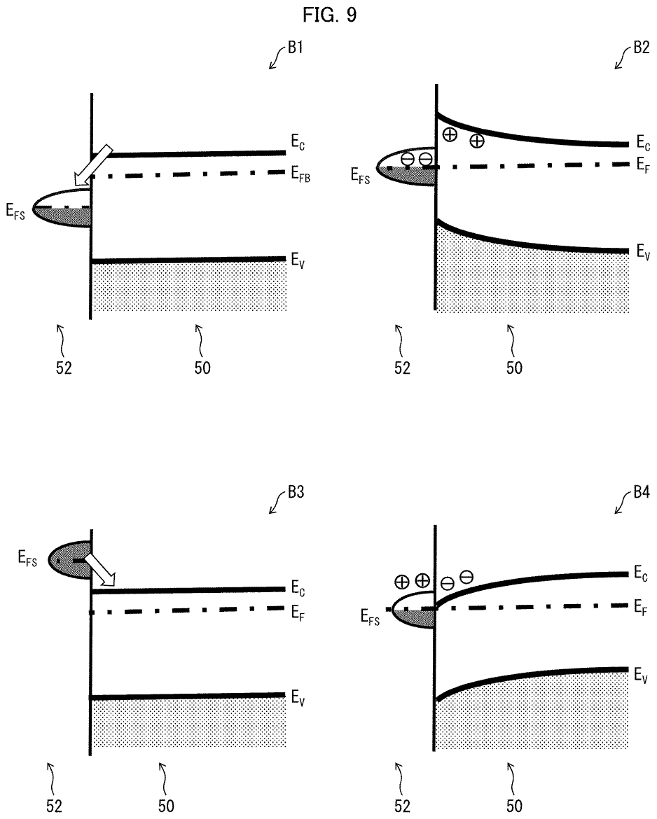

FIG. 9 shows band diagrams for illustrating how the valence band and the conduction band in the vicinity of the surface of the sample X bend due to the surface charge of the sample X. Each of the band diagrams shown in FIG. 9 shows a state in a bulk 50 of the sample X that is an n-type semiconductor and a state on a surface 52 of the bulk 50. Band diagrams B1 and B2 show an example of a behavior in each state in a case where an electron defect occurs at the surface 52 of the sample X. Band diagrams B3 and B4 show an example of a behavior in each state in a case where a local charge occurs on the surface 52 of the sample X.

In a case where an electron defect occurs at the surface 52 of the sample X, the surface 52 has a Fermi level E_{FS}, which is lower than the Fermi level E_{FB} of the bulk 50, as shown in the band diagram B1. In this state, transfer of electrons occurs from the bulk 50 to the electron defect at the surface 52 so as to equalize the Fermi level E_{FB} of the bulk 50 and the Fermi level E_{FS} of the surface 52. Thus, as shown in the band diagram B2, the difference between the Fermi level E_{FB} of the bulk 50 and the Fermi level E_{FS} of the surface 52 is reduced. Then, the bulk 50 in the vicinity of the electron defect is locally positively charged, and the surface 52 in the vicinity of the electron defect is locally negatively charged.

Therefore, between the bulk 50 and the surface 52 in the vicinity of the electron defect, an electric field occurs due to local charges. It should be noted here that since the bulk 50 is positively charged and the surface 52 is negatively charged, both of a valence band level E_{V} and a conduction band level E_{C} are bent upward in the band diagram in the bulk 50 in the vicinity of the surface 52, as shown in the band diagram B2.

In contrast, in a case where local electrons are present on the surface 52 of the sample X, the Fermi level E_{FS} of the surface 52 is higher than the Fermi level E_{FB} of the bulk 50, as shown in the band diagram B3. In this state, some of the local electrons on the surface 52 transfer to the bulk 50 so as to equalize the Fermi level E_{FB} of the bulk 50 and the Fermi level E_{FS} of the surface 52. Thus, as shown in the band diagram B4, the difference between the Fermi level E_{FB} of the bulk 50 and the Fermi level E_{FS} of the surface 52 is reduced. Then, in the vicinity of a position where the transfer of electrons has occurred, the bulk 50 is locally negatively charged and the surface 52 is locally positively charged.

Therefore, in the vicinity of the position, an electric field is produced, by the local charges, between the bulk 50 and the surface 52. It should be noted here that since the bulk 50 is negatively charged and the surface 52 is positively charged, both of the valence band level E_{V} and the conduction band level E_{C} are bent downward in the band diagram in the bulk 50 in the vicinity of the surface 52, as shown in the band diagram B4.

<Behavior of Band Bending in State in which External Electric Field is Given>

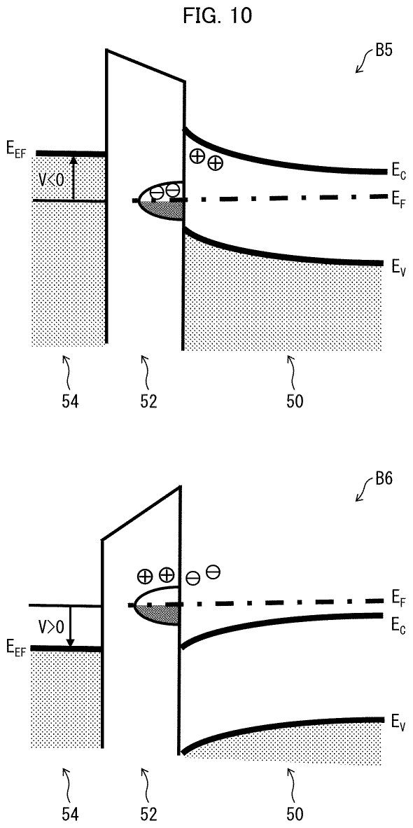

Next, the following description will discuss the behavior of the valence band and the behavior of the conduction band in the vicinity of the surface of the sample X, in a case were an external electric field occurs in the vicinity of the surface of the sample X in a state in which the valence band and the conduction band in the vicinity of the surface of the sample X are bent. FIG. 10 shows band diagrams that further illustrate, in addition to the state in the bulk 50 of the sample X that is the n-type semiconductor and the state at the surface 52 of the bulk 50, a state of an external electrode 54 which is brought close to the surface 52. Note that each of the band diagrams shown in FIG. 10 shows an equilibrium state in which the transfer of electrons between the bulk 50 and the electron defect at the surface 52 has occurred sufficiently.

In a case where the potential of the external electrode 54 is negative, the Fermi level EEF of the external electrode 54 shifts upward in the band diagram as shown in a band diagram B5 of FIG. 10, as compared with a case where the potential of the external electrode 54 is 0. As a result, an external electric field occurs between the external electrode 54 and the surface 52 of the sample X, and the Fermi level E_{FS} of the surface 52 in a steady state is further shifted downward in the band diagram. In this case, since the transfer of electrons from the bulk 50 to the electron defect at the surface 52 further progresses, the valence band level E_{V} and the conduction band level E_{C} of the bulk 50 are further bent upward in the band diagram as shown in the band diagram B5.

On the other hand, in a case where the potential of the external electrode 54 is positive, the Fermi level EEF of the external electrode 54 shifts downward in the band diagram as shown in a band diagram B6 of FIG. 10, as compared with the case where the potential of the external electrode 54 is 0. As a result, an external electric field occurs between the external electrode 54 and the surface 52 of the sample X, and the Fermi level E_{FS} of the surface 52 in the steady state is further shifted upward in the band diagram. In this case, since the transfer of electrons from the bulk 50 to the electron defect at the surface 52 is reduced, the valence band level E_{V} and the conduction band level E_{C} of the bulk 50 less bend.

Further, as a result of increasing the potential of the external electrode 54, the Fermi level E_{FS} of the surface 52 in the steady state becomes higher than the Fermi level EF of the bulk 50, and the transfer of electrons from the electron defect of the surface 52 to the bulk 50 may occur, as shown in the band diagram B6. In this case, as shown in the band diagram B6, the valence band level E_{V} and the conduction band level E_{C} of the bulk 50 are bent downward in the band diagram.

Thus, in a case where band bending occurs in the bulk 50 of the sample X, the degree of the bending of the bands of the bulk 50 or the direction of the bending is varied by varying the external electric field that occurs in the vicinity of the surface 52.

It should be noted here that in a case where the external electrode 54 is replaced with the cantilever probe 4 in accordance with the present embodiment, application of a potential to the external electrode 54 corresponds to application of a potential to the stage electrode 14 in accordance with the present embodiment. In a case where the bending of the band occurs in the vicinity of the surface 52 of the bulk 50, a change occurs in a vibration component of the cantilever probe 4.

### <Reaction Rate of Charge Transfer>

Next, the following description will discuss a reaction rate of charge transfer between the bulk 50 and the surface 52. The reaction rate of capture of electrons from the bulk 50 in surface states of the surface 52 is expressed by the following formula (1), and the reaction rate of electron emission to the bulk 50 in the surface states of the surface 52 is expressed by the following formula (2).

$$\frac{d {n}_{s}}{d T} = {C}_{n} n ( 1 - {n}_{s} ) \qquad ( 1 )$$

$$\frac{d {n}_{s}}{dt} = - {e}_{n} {n}_{s} \qquad ( 2 )$$

In the above formulae (1) and (2), nₛ indicates an electron occupancy rate of the surface states. In formula (1), Cₙ is an electron capture coefficient, and in formula (2), eₙ is an electron emission coefficient. It should be noted here that when attention is focused on the electron emission from the surface 52 to the bulk 50, the time constant t corresponding to the time of the transfer of electrons from the surface 52 to the bulk 50 is defined by the following formula (3).

$$τ = \frac{1}{{e}_{n}} = {τ}_{0} exp \{ \frac{Δ E}{η {k}_{B} T} \} \qquad ( 3 )$$

In formula (3), to is a lifetime in the steady state, KB is the Boltzman constant, and T is a temperature of the sample X. In formula (3), n is a correction term, and typically takes a value from 1 to 2. ΔE in formula (3) is a difference between the Fermi level E_{FS} of the surface 52 and the Fermi level EF of the bulk 50 prior to electron emission from the surface 52 into the bulk 50. With the above formula (3), the above formula (2) can be transformed into the following formula (4).

$$\frac{d {n}_{s}}{d t} = - \frac{{n}_{s}}{τ} \qquad ( 4 )$$

According to formula (4), the time required for electron emission from the surface 52 to the bulk 50 is proportional to the time constant τ. When the time constant t is increased, the time required for the electron emission from the surface 52 to the bulk 50 becomes longer. In other words, as the time constant t increases, the time required to cause the bending of the bands of the bulk 50 becomes longer due to the electron emission from the surface 52 to the bulk 50. Therefore, in a case where the external electric field that occurs in the vicinity of the surface 52 changes and consequently the Fermi level E_{FS} of the surface 52 changes, the bending of the bands of the bulk 50 may not follow the change of the Fermi level E_{FS} of the surface 52 in a case where a variation of the Fermi level E_{FS} occurs faster than a certain rate.

### <Cutoff Frequency>

It is assumed here that, for example, an AC signal is applied to the external electrode 54, and the external electric field that is generated between the external electrode 54 and the surface 52 is periodically varied. In this case, while the AC signal has a low frequency, the bending of the bands of the bulk 50 follows the variation of the Fermi level E_{FS} of the surface 52. However, when the AC signal has a frequency higher than a certain value, the bending of the bands of the bulk 50 no longer follows the variation of the Fermi level E_{FS} of the surface 52. On the premise that the frequency at which the bending of the bands of the bulk 50 no longer follows the variation of the Fermi level E_{FS} of the surface 52 is defined as a cutoff frequency f_{c}, the cutoff frequency f_{c} is expressed by the following formula (5).

$${f}_{c} = \frac{1}{2 π τ} \qquad ( 5 )$$

According to the formulae (3) and (5), when there is a greater difference ΔE between the Fermi level E_{FS} of the surface 52 and the Fermi level EF of the bulk 50, the cutoff frequency f_{c} is lower. Meanwhile, when the sample X has a higher temperature, the cutoff frequency f_{c} is lower.

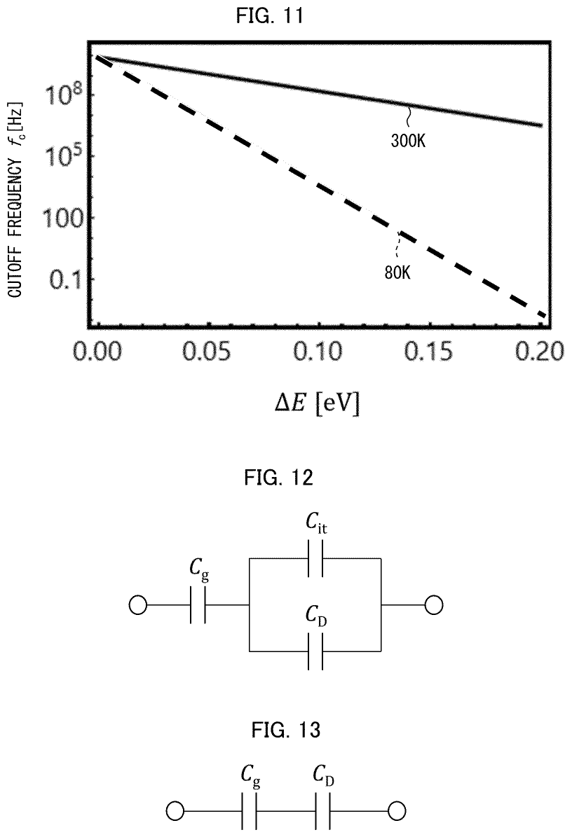

The following will discuss in more detail a relation between the cutoff frequency f_{c} and ΔE with reference to a graph shown in FIG. 11. In the graph shown in FIG. 11, the vertical axis represents the cutoff frequency f_{c} [Hz], and the horizontal axis represents ΔE [eV]. In the graph shown in FIG. 11, a case where the temperature of the sample X is 300K is shown by a solid line, and a case where the temperature of the sample X is 80K is shown by a dotted line.

For example, when the temperature of the sample X is 80K and ΔE is 0.1 eV, the cutoff frequency f_{c} is 166 kHz. Therefore, in the above case, when a signal at a frequency of not less than 166 kHz is applied to the external electrode 54 and the external electric field is varied, the bending of the bands generated in the bulk 50 of the sample X does not follow such a variation of the external electric field and does not vary to a large extent.

### <Method of Calculating Interface State Density: Consideration of Electrostatic Force>

Next, the following description will discuss a method of calculating the interface state density at an interface of the sample X from the electric capacitance between the cantilever probe 4 and the sample X. In the following discussion, an MIS structure is used as a model and a consideration is made. In this MIS structure, a contact potential difference between the cantilever probe 4 and the sample X is 0.

First, for simplicity, it is assumed that the cantilever probe 4 and the sample X form a parallel plate capacitor. It is further assumed that due to excitation by the probe control section 10, the cantilever probe 4 is vibrating at A cos 2π f₁ t, where A represents a vibration amplitude of the cantilever probe 4. Note that, in the above assumption, in a case where there is no interaction between the cantilever probe 4 and the sample X, the cantilever probe 4 vibrates at the frequency f₁.

In a case where a bias voltage is applied between the cantilever probe 4 and the sample X, the electrostatic force Fₑₗₑ that acts on the cantilever probe 4 is expressed by the following formula.

$${F}_{ele} = - \frac{{Q}^{2}}{2 {ε}_{0}}$$

It should be noted here that Q represents a charge density induced at a surface of the sample X and co represents a dielectric constant of vacuum.

It is assumed that a voltage V=V_{dc}+V_{ac} cos 2π ft, in which the AC voltage V_{dc} cos 2π ft at a modulation frequency f and at a vibration amplitude V_{ac} is superimposed on the DC signal having the voltage V_{dc}, is applied between the cantilever probe 4 and the sample X. In this case, a component at the modulation frequency f of the electrostatic force that acts between the cantilever probe 4 and the sample X is expressed as the following formula by using a Taylor series expansion.

$${F}_{ele} ( f ) = - \frac{{dF}_{ele}}{d V} {V}_{a c} cos 2 π ft = - \frac{{dF}_{ele} ( Q )}{dQ} \frac{d Q}{d {V}_{s}} \frac{d {V}_{s}}{d V} {V}_{a c} cos 2 π ft$$

It should be noted here that Vs represents a surface potential of the sample X.

### <Method of Calculating Interface State Density: Consideration of Charge Density>

Next, the following description will discuss a charge density Q that is induced on a surface of the sample X. In a case where a bias voltage is applied between the cantilever probe 4 and the sample X, a surface potential occurs on a surface of the sample X. As a result, on the surface of the sample X, for example, accumulation of charge, formation of a depletion layer, or formation of an inversion layer occurs. Therefore, in considering the charge density at the surface of the sample X, it is necessary to take into account the surface potential of the sample X.

On the other hand, a surface potential is present on the surface of the sample X as described above. Further, as described above, in a case where an AC signal is applied to the sample X, capture or emission of the charge between the bulk 50 and the surface 52 due to a change in the surface potential contributes to an interaction between the cantilever probe 4 and the sample X. Accordingly, it is also necessary to take into account the surface states of the sample X in considering the charge density at the surface of the sample X.

Therefore, the total charge density Q at the surface of the sample X is expressed by the sum of the charge density Qₛ that is caused by the surface potential of the sample X and the charge density Qₛₛ that is caused by the surface states. In other words, Q=Qₛ+Qₛₛ is true.

### <Method of Calculating Interface State Density: Consideration of Charge Density in Case of Low-Frequency Bias Voltage>

For a case where the bias voltage applied to the sample X is an AC bias voltage V_{ac} cos 2π fₘ t which has a frequency fₘ that is lower than the cutoff frequency f_{c} described above, the charge density Q is considered. In a case where the bias voltage applied to the sample X is a low-frequency voltage, the following need to be considered: charge transfer occurs between the bulk 50: and the surface 52 and that the surface states contribute to the charge density Q. Therefore, the following formulae are true.

$$\frac{dQ}{{dV}_{s}} = \frac{d ( {Q}_{s} + {Q}_{ss} )}{{dV}_{s}} = {C}_{D} + {C}_{it}$$

$$\frac{{dV}_{s}}{dV} = \frac{{C}_{g}}{{C}_{g} + {C}_{D} + {C}_{it}}$$

$${V}_{DC} = {V}_{S} + \frac{{Q}_{s} + {Q}_{ss}}{{C}_{g}}$$

$${V}_{S} = \frac{{Q}_{s} + {Q}_{ss}}{{C}_{D} + {C}_{it}}$$

It should be noted here that C_{g} represents capacitance due to a gap between the cantilever probe 4 and the sample X. C_{D} represents capacitance due to a depletion layer of a semiconductor. Cᵢₜ represents capacitance due to interface charge. Accordingly, a modulation frequency component Fₑₗₑ(fₘ) of the electrostatic force is expressed by the following formula.

$$\begin{matrix}{F}_{ele} ( {f}_{m} ) = - \frac{{Q}_{s} + {Q}_{ss}}{{ε}_{0}} \frac{{C}_{g} ( {C}_{D} + {C}_{it} )}{{C}_{g} + {C}_{D} + {C}_{it}} {V}_{ac} cos 2 π {f}_{m} t \\ = \frac{{C}_{g} ( {V}_{S} - {V}_{DC} )}{{ε}_{0}} {C}_{LF} {V}_{ac} cos 2 π {f}_{m} t \\ = \frac{{C}_{g} ( \frac{{Q}_{s} + {Q}_{ss}}{{C}_{D} + {C}_{it}} - {V}_{DC} )}{{ε}_{0}} {C}_{LF} {V}_{ac} cos 2 π {f}_{m} t\end{matrix}$$

It should be noted here that CLF represents the capacitance between the cantilever probe 4 and the sample X in a case where a low-frequency AC bias is applied to the sample X, and is expressed by the following formula.

$${C}_{L F} = \frac{{C}_{g} ( {C}_{D} + {C}_{i t} )}{{C}_{g} + {C}_{D} + {C}_{i t}}$$

The capacitance CLF is expressed by an equivalent circuit illustrated in FIG. 12. This is equivalent to a circuit in which a resistance component is ignored in an equivalent circuit of a Shockley-Read model, which is an impedance model of the MIS-structure. This suggests that a technique for evaluating a surface or interface of a sample X is similar to a technique for conventional impedance measurement or electrostatic force measurement.

The electrostatic force that acts between the cantilever probe 4 and the sample X ultimately becomes electrostatic force F_{ele,L}(f₁±fₘ) which has a frequency f₁±fₘ component as a result of mixing the electrostatic force caused by the AC bias voltage and vibration of the cantilever. On the assumption that the mean distance between the probe and the sample is zₜ₀ and the vibration amplitude of the cantilever is A, the distance z between the probe and the sample is given as z=zₜ₀+A cos 2π f₁ t. It should be noted here that the following formula is true.

$$\frac{\partial }{\partial x} [ \frac{{C}_{g}}{{ε}_{0}} {C}_{LF} ] \approx - ( {C}_{D} + {C}_{it} ) [ \frac{1}{{z}_{to}^{2}} - \frac{1}{{( {z}_{to} + \frac{{ε}_{0}}{{C}_{D} + {C}_{it}} )}^{2}} ] A cos 2 π {f}_{1} t$$

Therefore, the electrostatic force F_{ele,L}(f₁±fₘ) which has the frequency f₁±fₘ component is expressed by the following formula.

$${F}_{ele , L} ( {f}_{1} \pm {f}_{m} ) = - \frac{1}{2} ( {C}_{D} + {C}_{it} ) [ \frac{1}{{z}_{to}^{2}} - \frac{1}{{( {z}_{to} + \frac{{ε}_{0}}{{C}_{D} + {C}_{it}} )}^{2}} ] ( \frac{{Q}_{s} + {Q}_{ss}}{{C}_{D} + {C}_{it}} - {V}_{DC} ) {V}_{ac} A cos ( {f}_{1} \pm {f}_{m} )$$

In a case where as in the vibration component measuring device 2 in accordance with the present embodiment, the electrostatic force is demodulated, by a frequency modulation method, from the signal obtained by the optical sensor 18, a frequency shift signal of the cantilever is modulated by the electrostatic force F_{ele,L}(f₁±fₘ). Consequently, the modulated component Δf_{L}(fₘ) of the frequency shift is expressed by the following formula in a case where k is defined as the effective spring constant.

$$Δ {f}_{L} ( {f}_{m} ) = - \frac{{f}_{1}}{2 kA} [ {F}_{ele , L} ( {f}_{1} + {f}_{m} ) + {F}_{ele , L} ( {f}_{1} - {f}_{m} ) ] = \frac{{f}_{1}}{4 k} ( {C}_{D} + {C}_{it} ) [ \frac{1}{{z}_{to}^{2}} - \frac{1}{{( {z}_{to} + \frac{{ε}_{0}}{{C}_{D} + {C}_{it}} )}^{2}} ] ( \frac{{Q}_{s} + {Q}_{s s}}{{C}_{D} + {C}_{it}} - {V}_{DC} ) {V}_{a c} cos 2 π {f}_{m} t$$

In the above formula, the zₜ₀ is assumed to be sufficiently smaller than the depth of a depletion region of the sample X. In other words, it is assumed that zₜ₀<< ε₀/(C_{D}+Cᵢₜ) is true. In this case, it can be said that the slope of DC-bias-voltage dependence of the modulated component Δf_{L}(fₘ) is proportional to electrostatic capacitance C_{D}+Cᵢₜ inside the sample X at a low-frequency AC bias.

### <Method of Calculating Interface State Density: Consideration of Charge Density in Case of High-Frequency Bias Voltage>

Next, for a case where the bias voltage applied to the sample X is an AC bias voltage V_{ac} cos 2π (2f₁±fₘ) t which has a frequency 2f₁±fₘ that is higher than the cutoff frequency f_{c} described above, the charge density Q is considered. In a case where the bias voltage applied to the sample X is a high-frequency bias voltage, charge transfer between the bulk 50 and the surface 52 no longer occurs. Therefore, in this case, it is possible to ignore the contribution of the charge density Qₛₛ, which is caused by the surface states, to the charge density Q. Therefore, the following formulae are true.

$$\frac{dQ}{{dV}_{s}} = \frac{{dQ}_{s}}{{dV}_{s}} = {C}_{D}$$

$$\frac{{dV}_{s}}{dV} = \frac{{C}_{g}}{{C}_{g} + {C}_{D}}$$

$${V}_{DC} = {V}_{S} + \frac{{Q}_{s}}{{C}_{g}}$$

$${V}_{S} = \frac{{Q}_{s}}{{C}_{D}}$$

Thus, the modulation frequency component Fₑₗₑ(2f₁+fₘ) of the electrostatic force is expressed by the following formula.

$${F}_{e l e} ( 2 {f}_{1} + {f}_{m} ) = - \frac{Q}{{ε}_{0}} \frac{{C}_{g} {C}_{D}}{{C}_{g} + {C}_{D}} {V}_{a c} = \frac{{C}_{g} ( {V}_{S} - {V}_{D C} )}{{ε}_{0}} {C}_{HF} {V}_{a c} cos 2 π ( 2 {f}_{1} + {f}_{m} ) t = \frac{{C}_{g} ( \frac{{Q}_{s}}{{C}_{D}} \to {V}_{D C} )}{{ε}_{0}} {C}_{HF} {V}_{ac} cos 2 π ( 2 {f}_{1} + {f}_{m} ) t$$

It should be noted here that C_{HF} represents the capacitance between the cantilever probe 4 and the sample X in a case where a high-frequency AC bias is applied to the sample X, and is expressed by the following formula.

$${C}_{HF} = \frac{{C}_{g} {C}_{D}}{{C}_{g} + {C}_{D}}$$

The capacitance C_{HF} is expressed by an equivalent circuit illustrated in FIG. 13. This is equivalent to a circuit in which the capacitance Cᵢₜ is further ignored in the equivalent circuit illustrated in FIG. 12.

The electrostatic force that acts between the cantilever probe 4 and the sample X ultimately becomes electrostatic force F_{ele,H}(f₁+f m) which has a frequency f₁+fₘ component as a result of mixing the electrostatic force caused by the AC bias voltage and vibration of the cantilever. It should be noted here that the following formula is true.

$$\frac{\partial }{\partial x} [ \frac{{C}_{g}}{{ε}_{0}} {C}_{HF} ] \approx - {C}_{D} [ \frac{λ}{{z}_{to}^{2}} - \frac{1}{{( {z}_{t o} + \frac{{ε}_{0}}{{C}_{D}} )}^{2}} ] A cos 2 {πf}_{1} t$$

Therefore, the electrostatic force F_{ele,H}(f₁+fₘ) which has the frequency f₁+fₘ component is expressed by the following formula.

$${F}_{ele , L} ( {f}_{1} + {f}_{m} ) = - \frac{1}{2} {C}_{D} [ \frac{1}{{z}_{to}^{2}} - \frac{1}{{( {z}_{to} + \frac{{ε}_{0}}{{C}_{D}} )}^{2}} ] ( \frac{{Q}_{s}}{{C}_{D}} - {V}_{DC} ) {V}_{ac} A cos ( {f}_{1} \pm {f}_{m} )$$

In a case where, as in the vibration component measuring device 2 in accordance with the present embodiment, the electrostatic force is demodulated, by the frequency modulation method, from the signal obtained by the optical sensor 18, a frequency shift signal of the cantilever is modulated by the electrostatic force F_{ele,H}(f₁+fₘ). Consequently, the modulated component Δf_{H}(fₘ) of the frequency shift is expressed by the following formula.

$$Δ {f}_{H} ( {f}_{m} ) = - \frac{{f}_{1}}{2 kA} {F}_{ele , L} ( {f}_{1} + {f}_{m} ) = \frac{{f}_{1}}{8 k} {C}_{D} [ \frac{1}{{z}_{to}^{2}} - \frac{1}{{( {z}_{to} + \frac{{ε}_{0}}{{C}_{D}} )}^{2}} ] ( \frac{{Q}_{s}}{{C}_{D}} - {V}_{DC} ) {V}_{a c} cos 2 π {f}_{m} t$$

Also in the above formula, the zₜ₀ is assumed to be sufficiently smaller than the depth of a depletion region of the sample X. In other words, it is assumed that zₜ₀<<ε₀/C_{D} is true. In this case, it can be said that the slope of DC-bias-voltage dependence of the modulated component Δf_{H}(fₘ) is proportional to capacitance Cp inside the sample X in a high-frequency AC bias. Note that whereas modulated components of both side bands are demodulated in derivation of the modulated component Δf_{H}(fₘ), a modulated component of one of the side bands is demodulated in derivation of the modulated component Δf_{L}(fₘ). Therefore, the coefficient of the modulated component Δf_{H}(fₘ) is half the coefficient of the modulated component Δf_{L}(fₘ).

### <Method of Calculating Interface State Density: Consideration of Interface Charge>

Next, the following description will discuss a charge density Qₛₛ at an interface, in view of a relational expression between respective modulated components in a case where the bias voltage applied to the sample X is a low-frequency bias voltage and in a case where the bias voltage applied to the sample X is a high-frequency bias voltage. In a case where a low-frequency AC bias voltage is used in measurement using the vibration component measuring device 2, a DC bias voltage VDC (LF) whose modulated component Δf_{L}(fₘ) of the frequency shift is 0 is expressed by the following formula.

$${V}_{DC ( LF )} = \frac{{Q}_{s} + {Q}_{ss}}{{C}_{D} + {C}_{it}}$$

In light of the above formula, in a case where measurement using a low-frequency AC bias voltage is carried out, it is possible to obtain, by obtaining contact potential difference between the cantilever probe 4 and the sample X, information on a surface potential obtained by adding the surface potential due to the surface states to the surface potential due to a bulk state of the sample X. On the other hand, in a case where a high-frequency AC bias voltage is used in measurement using the vibration component measuring device 2, a DC bias voltage V_{DC(HF)} whose modulated component Δf_{H}(fₘ) of the frequency shift is 0 is expressed by the following formula.

$${V}_{D C ( H F )} = \frac{{Q}_{s}}{{C}_{D}}$$

In light of the above formula, in a case where measurement using a high-frequency AC bias voltage is carried out, it is possible to obtain, by obtaining contact potential difference between the cantilever probe 4 and the sample X, only information on a surface potential due to a bulk state of the sample X. Therefore, a difference between the contact potential difference of the low-frequency AC bias voltage and the contact potential difference of the high-frequency AC bias voltage is obtained, by the vibration component measuring device 2 in accordance with the present embodiment, with use of the low-frequency AC bias voltage and the high-frequency AC bias voltage, so that it is possible to obtain information on the surface potential due to the surface states.

<Method of Calculating Interface State Density: Derivation of Interface State Density from Modulated Components>

Next, the following description will discuss derivation of the interface state density Dᵢₜ of the sample X from a relational expression between respective modulated components of a case where the bias voltage applied to the sample X is a low-frequency voltage and in a case where the bias-voltage applied is a high-frequency voltage. In a case where the AC bias voltage applied to the sample X is a low-frequency voltage, the slope of the modulated component Δf_{L}(fₘ) with respect to the DC bias voltage is proportional to the capacitance C_{D}+Cᵢₜ inside the sample X. On the other hand, in a case where the AC bias voltage applied to the sample X is a high-frequency voltage, the slope of the modulated component Δf_{L}(fₘ) with respect to this DC bias voltage is proportional to the capacitance C_{D} inside the sample X.

From these relational expressions, the interface state density Dᵢₜ at the surface of the sample X in a case where each bias voltage is applied to the sample is calculated from a difference, in the slope of the modulated component Δf_{L}(fₘ) with respect to the DC bias voltage, between a case where the bias voltage applied to the sample X is a low-frequency voltage and in a case where the bias voltage applied to the sample X is a high-frequency voltage. Thus, with use of an elementary charge e, the interface state density Dᵢₜ of the sample X is expressed by the following formula.

$${D}_{i t} = \frac{{C}_{i t}}{{e}^{2}} = \frac{1}{{e}^{2}} [ ( ( {C}_{D} + {C}_{i t} ) - {C}_{D} ]$$

The vibration component measuring device 2 in accordance with the present embodiment carries out the above-described analysis in the analyzing section 44. Thus, the vibration component measuring device 2 calculates the slope of the modulated component Δf(fₘ) with respect to the voltage V_{dc} of the DC signal, while switching the frequency applied to the sample X between a high frequency and a low frequency. As a result, the vibration component measuring device 2 in accordance with the present embodiment calculates, in the analyzing section 44, a difference between the slope in a case where the frequency applied to the sample X is a high frequency and the slope in a case where the frequency applied to the sample X is a low frequency. The interface state density of the sample X can be thus measured.

More specifically, while employing, as DC signals, at least a first DC signal and a second DC signal which has a voltage that is different from a voltage of the first DC signal, the vibration component measuring device 2 measures the modulated component Δf(fₘ) in each of the cases of the first DC signal and the second DC signal. This allows the vibration component measuring device 2 to measure, from the slope of the modulated component Δf(fₘ), the capacitance between the cantilever probe 4 and the sample X.

Further, while switching, between the second AC signal and the reference AC signal, the AC signal which is contained in the voltage applied to the sample X, the vibration component measuring device 2 measures the modulated component Δf(fₘ) in each of the cases of the second AC signal and the reference AC signal. Thus, the vibration component measuring device 2 can measure, from a difference in slope of the modulated component Δf(fₘ), a difference in capacitance between the cantilever probe 4 and the sample X for each of a case where the signal applied to the sample X has a high frequency and a case where the signal applied to the sample has a low frequency.

In particular, in the first operation of the vibration component measuring device 2 in accordance with the present embodiment, the signal applied to the sample X has a frequency that is higher than the above-described cutoff frequency f_{c}, and in the second operation of the vibration component measuring device 2, the signal applied to the sample X has a frequency that is lower than the cutoff frequency f_{c}. In this case, the vibration component measuring device 2 can measure the interface state density of the sample X from a difference between (i) the capacitance measured between the cantilever probe 4 and the sample X in the first operation and (ii) the capacitance measured between the cantilever probe 4 and the sample X in the second operation.

### <Consideration of State of Sample Surface by Measurement of Modulated Component>

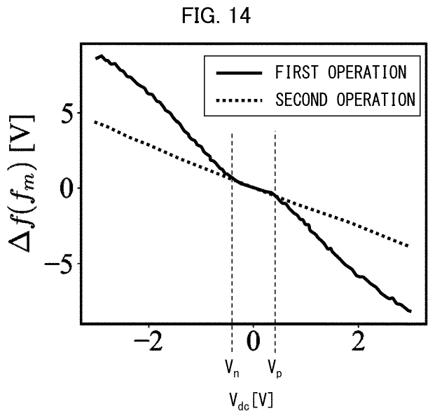

Next, the surface state of the sample X is considered from an example of a result of actual measurement of the modulated component Δf(fₘ) by the vibration component measuring device 2. FIG. 14 is a graph showing respective results of measurement of the modulated component Δf(fₘ) in the first operation and the second operation of the vibration component measuring device 2. The modulated component Δf(fₘ) was measured while the voltage V_{dc} of the DC signal was being changed. In the graph of FIG. 14, the horizontal axis represents the voltage V_{dc} of the DC signal and the vertical axis represents the modulated component Δf(fₘ).

As illustrated in FIG. 14, it is clear that the value of the modulated component Δf(fₘ) for each voltage V_{dc} and the slope of the modulated component Δf(fₘ) with respect to the voltage V_{dc} are different between the first operation and the second operation of the vibration component measuring device 2. This indicates that a change occurs in the capacitance between the cantilever probe 4 and the sample X depending on whether the AC signal which is included in a signal applied to the sample X has a high frequency or a low frequency.

Further, it is noticeable and clear in the graph for the first operation in FIG. 14 that the slope of the modulated component Δf(fₘ) with respect to the voltage V_{dc} differs depending on the voltage V_{dc}. It should be noted here that a change in the slope of the modulated component Δf(fₘ) with respect to the voltage V_{dc} in accordance with a change in the voltage V_{dc} represents a change in state of charges which are induced at the surface of the sample X.

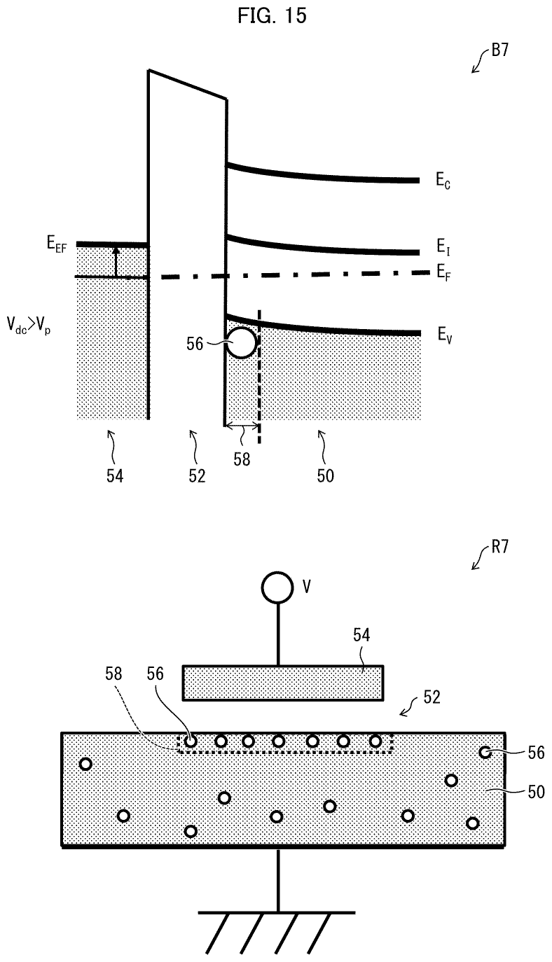

As illustrated in FIG. 14, assume that values of the voltage V_{dc}, at which a large change occurs in the slope of the modulated component Δf(fₘ) with respect to the voltage V_{ac} in the first operation are a high voltage Vₚ and a low voltage Vₙ, and Vₚ>Vₙ. With reference to FIGS. 15 to 17, the following description will discuss states of charges that are induced on the surface of the sample X in each of cases of V_{ac}>Vₚ, Vₚ≥V_{dc}≥Vₙ, and Vₙ>V_{dc}.

FIGS. 15 to 17 are respective band diagrams and respective schematic sectional side views in the vicinity of the surface 52 of the sample X in the cases of V_{dc}>Vₚ, Vₚ≥V_{ac}≥Vₙ, and Vₙ>V_{dc}. Note that, FIGS. 15 to 17 each show a state of an external electrode 54 which is brought close to the surface 52, and show a case where the sample X is a p-type semiconductor.

In the case of V_{dc}>Vₚ, each of the bands of the bulk 50 in the vicinity of the surface 52 of the sample X is bent upward, as shown in a band diagram B7 of FIG. 15. As a result, holes 56 are induced in a valence band in the vicinity of the surface 52 of the sample X. As a result, as shown in the band diagram B7 and a side sectional view R7 of FIG. 15, an accumulation layer 58 is formed, by the holes 56 induced, in the vicinity of the surface 52 of the sample X that faces the external electrode 54.

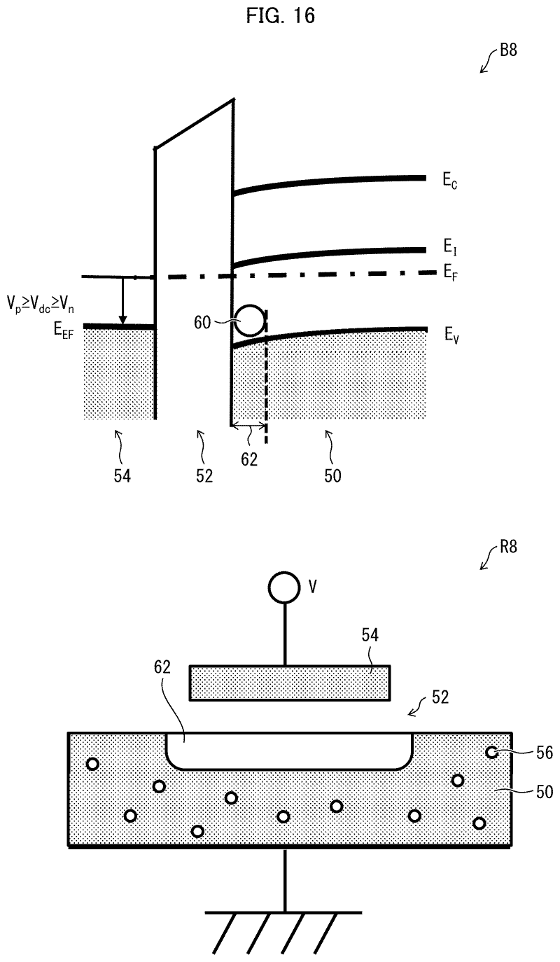

In the case of Vₚ≥V_{dc}≥Vₙ, each of the bands of the bulk 50 in the vicinity of the surface 52 of the sample X is bent slightly downward, as shown in a band diagram B8 of FIG. 16. This induces negative accepter ions 60 in the vicinity of the surface 52 of the sample X. Thus, as shown in the band diagram B8 and a side sectional view R8 of FIG. 16, a depletion layer 62 is formed in the vicinity of the surface 52 of the sample X that faces the external electrode 54. The depletion layer 62 is formed by coupling of the acceptor ions 60 and the holes 56 in the bulk 50.

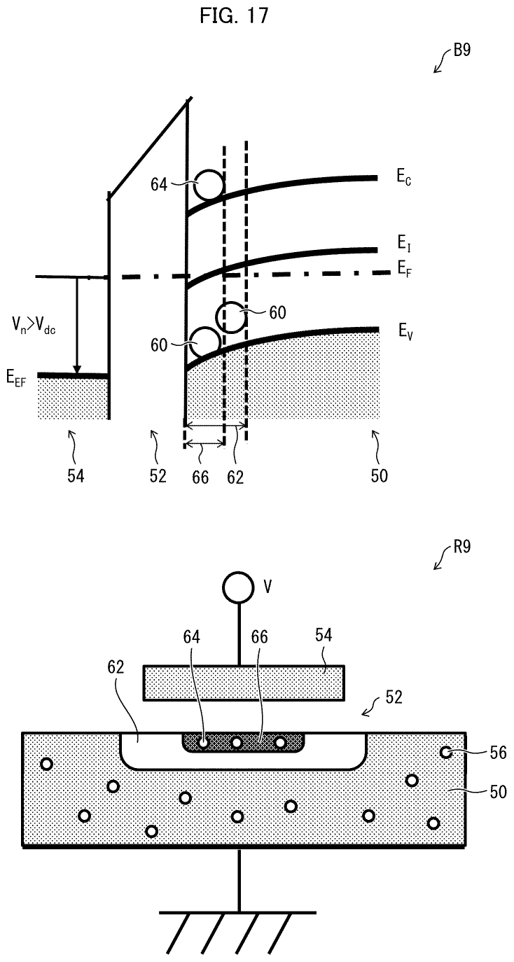

In the case of Vₙ>V_{dc}, each of the bands of the bulk 50 in the vicinity of the surface 52 of the sample X is further bent downward as shown in a band diagram B9 of FIG. 17. As a result, in the conduction band in the vicinity of the surface 52 of the sample X, conduction electrons 64 are further induced. As a result, as shown in the band diagram B9 and a side sectional view R9 of FIG. 17, in the vicinity of the surface 52 of the sample X that faces the external electrode 54, an inversion layer 66 is formed by the conduction electrons 64 in the depletion layer 62.

As described above, the surface state of the sample X changes depending on the voltage V_{dc} of the DC signal applied to the sample X. Therefore, conversely, the vibration component measuring device 2 can measure the state of the surface of the sample X by measuring the modulated component Δf(fₘ) concurrently with changing the voltage V_{dc}.

### Recapitulation of Embodiment 1

The vibration component measuring device 2 in accordance with the present embodiment measures the above-described modulated component Δf(fₘ) as the varying component of the vibration of the cantilever probe 4 while applying a signal between the cantilever probe 4 and the sample X. It should be noted here that the signal is a signal in which a DC signal, and a second AC signal and/or an AC signal are superimposed on each other. The vibration component measuring device 2 also applies, between the cantilever probe 4 and the sample X, at least two signals as DC signals. The two signals include a first DC signal and a second DC signal which are different from each other at least in voltage.

This allows the vibration component measuring device 2 to measure a change of the modulated component Δf(fₘ) with respect to a change in the DC component of the signal applied to the sample X, for each of a case where the AC component of the signal applied to the sample X has a low frequency and a case where the AC component has a high frequency. Thus, the vibration component measuring device 2 can measure, from the change of the modulated component Δf(fₘ) measured, a difference in the varying component between a case where the signal applied to the sample X has a low frequency and a case where the signal has a high frequency. In particular, in the present embodiment, the vibration component measuring device 2 can measure, from the change in the modulated component Δf(fₘ) measured, the interface state density at an interface such as a surface of the sample X.

The vibration component measuring device 2 in accordance with the present embodiment can obtain the modulated component Δf(fₘ), which is the varying component of the vibration of the cantilever probe 4, by modulating a measurement signal which includes, for example, a signal from the optical sensor 18. Therefore, the vibration component measuring device 2 can make a measurement more efficiently or at higher resolution as compared with a case described earlier in which the interface state density is measured in a macro region in which metal electrode regions are averaged.

The vibration component measuring device 2 makes interpretation of an obtained varying component easier and thus can more efficiently measure the interface state density of the sample X, as compared with a case where electrostatic force between the cantilever probe 4 and the sample X is directly measured. Further, unlike a case where the capacitance between the cantilever probe 4 and the sample X is directly measured, in the case of the vibration component measuring device 2, it is not necessary to take into account a stray capacitance between the probe 4 and the sample X, and thus it is possible to more easily measure the varying component. Further, the vibration component measuring device 2 can measure the varying component by the optical sensor 18 that is less expensive and has a simpler structure than a capacitive sensor for measuring the capacitance between the probe 4 and the sample X. Furthermore, the vibration component measuring device 2 can be operated in a variety of environments regardless of temperature, a magnetic field, a type of atmosphere, or the like surrounding the sample X.

As described above, the vibration component measuring device 2 in accordance with the present embodiment can more efficiently measure a change in the varying component of the vibration section, and thus can more efficiently calculate the interface state density of the sample X. The vibration component measuring device 2 in accordance with the present embodiment employs the cantilever probe 4 as the vibration section, measures, by the optical sensor 18, light which has been emitted from the light source 16 and reflected by the cantilever probe 4, and then measures the varying component of the vibration of the cantilever probe 4. Therefore, the vibration component measuring device 2 functions as a Kelvin probe force spectrometer that can measure the interface state density of the sample X.

### Embodiment 2

### <Measuring Device for First Derivative Value of Varying Component: First Operation>

The following description will discuss another embodiment of the present disclosure. For convenience of description, members having the same functions as those of the members described in the above embodiment are given the same reference numerals, and description thereof will not be repeated.

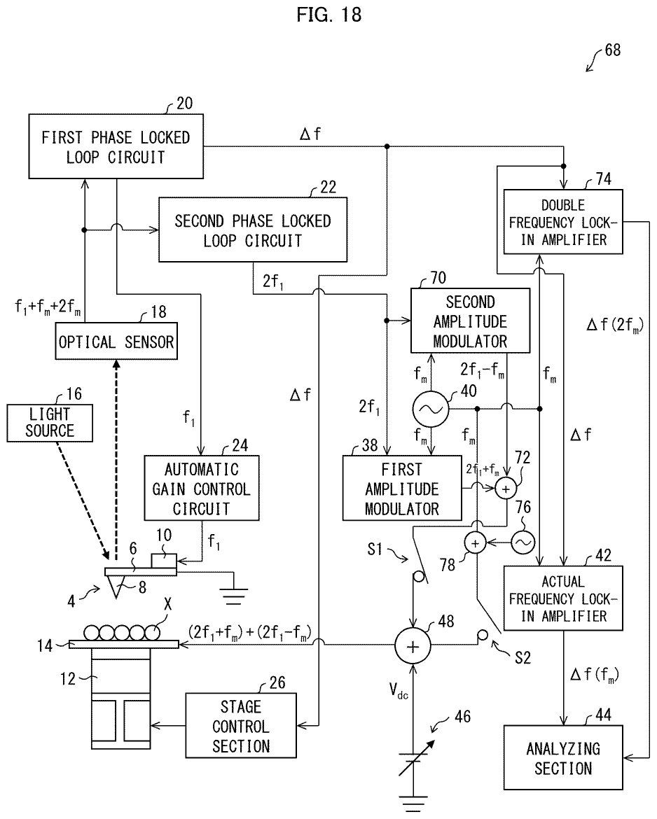

FIG. 18 is a block diagram for illustrating a configuration of a vibration component measuring device 68 in accordance with the present embodiment, and an operation of the vibration component measuring device 68.

The vibration component measuring device 68 in accordance with the present embodiment further includes, in the vibration component measuring device 2, a second amplitude modulator 70, an adder 72, a double frequency lock-in amplifier 74, an AC power source 76, and an adder 78. Except for the above, unless otherwise specifically mentioned, the vibration component measuring device 68 in accordance with the present embodiment has the same configuration as the vibration component measuring device 2.

The following description will discuss the operation of the vibration component measuring device 68, with reference to FIG. 18. In the present embodiment, as in the foregoing embodiment, first, the following description will discuss, as an example, an operation of the vibration component measuring device 68 in a state in which a first switch S1 is closed while a second switch S2 is open. This operation is referred to as a first operation.

In the first operation of the vibration component measuring device 68 in accordance with the present embodiment, a signal in which a DC signal and a second AC signal are superimposed on each other is applied to the sample X via a stage electrode 14. It should be noted here that, in the present embodiment, the second AC signal is a signal obtained by superimposing a first high frequency signal and a second high frequency signal on each other.

The first high frequency signal is an AC signal which has a frequency 2f₁+fₘ and which is outputted from a first amplitude modulator 38, as described later. The second high frequency signal is an AC signal which has a frequency 2f₁−fₘ and which is outputted from a second amplitude modulator 70, as described later. Therefore, a difference in frequency between the first high frequency signal and the second high frequency signal is 2fₘ, which is twice a frequency of a reference AC signal. In other words, the second high frequency signal has a frequency which is obtained by subtracting the frequency of the reference AC signal from a frequency that is twice the frequency of the first AC signal. Furthermore, in the present embodiment, the first high frequency signal and the second high frequency signal have opposite phases from each other.

In the present embodiment, as in the foregoing embodiment, the vibration component of the cantilever probe 4 is detected by using a so-called optical lever method with use of a light source 16 and an optical sensor 18. In the present embodiment, as in the foregoing embodiment, a signal which is outputted by the optical sensor 18 is a signal obtained by replacing, with a signal strength for each frequency, a vibration strength of the cantilever probe 4 for each vibration frequency of the cantilever probe 4, the vibration strength having been calculated by the optical sensor 18.

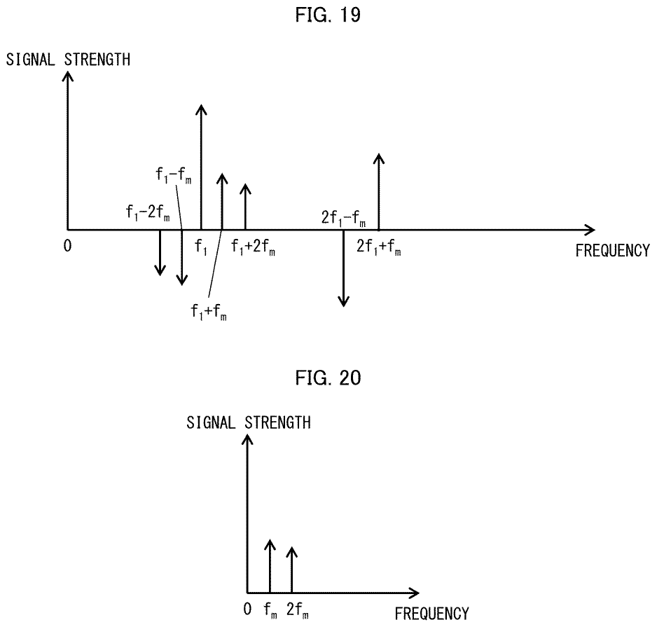

FIG. 19 is a graph which shows an example of a signal which is outputted by the optical sensor 18. In FIG. 19, as in FIG. 2, the horizontal axis represents the frequency of the signal which is outputted by the optical sensor 18 and the vertical axis represents the intensity of the signal which is outputted by the optical sensor 18. It should be noted here that, in FIG. 19, a component that has the signal strength set to be negative indicates that the component has an opposite phase from a component at the frequency f₁ at which the cantilever probe 4 vibrates.

In the present embodiment, between the cantilever probe 4 and the sample X, a second AC signal is applied. In the second AC signal, the first high frequency signal having the frequency 2f₁+fₘ and the second high frequency signal having the frequency 2f₁−fₘ are superimposed on each other. The vibration of the cantilever probe 4 thus has a component at a vibration frequency 2f₁+fₘ and a component at a vibration frequency 2f₁−fₘ.

Therefore, the signal which is outputted by the optical sensor 18 has a component at the frequency 2f₁+fₘ and a component at the frequency 2f₁−fₘ as shown in FIG. 19. However, since the first high frequency signal and the second high frequency signal have opposite phases from each other, for example, the component at the frequency 2f₁−fₘ has an opposite polarity with respect to the component at the frequency 2f₁+fₘ, as illustrated in FIG. 19.

In the present embodiment, the vibration of the cantilever probe 4 is modulated by each of the first high frequency signal and the second high frequency signal. The vibration of the cantilever probe 4 thus has, at vibration frequencies f₁+fₘ, f₁+2fₘ, f₁−fₘ, and f₁−2fₘ, side bands of the modulated component. Therefore, the signal which is outputted by the optical sensor 18 also has components at frequencies f₁+fₘ, f₁+2fₘ, f₁−fₘ, and f₁−2fₘ, as shown in FIG. 19. However, since the first high frequency signal and the second high frequency signal have opposite phases from each other, for example, the components at the frequencies f₁−fₘ and f₁−2fₘ have an opposite polarity with respect to the components at the frequencies f₁+fₘ and f₁+2fₘ, as illustrated in FIG. 19.

The signal which is outputted by the optical sensor 18 is inputted to a first phase locked loop circuit 20, as in the foregoing embodiment. It should be noted here that in the present embodiment, a pass band is set so that a low-pass filter of a PLL lock-in amplifier 28 which is provided in the first phase locked loop circuit 20 outputs a signal which has a frequency up to approximately the frequency 2fₘ. As a result, the first phase locked loop circuit 20 outputs a measurement signal that includes, as illustrated in FIG. 20, a varying component of the vibration of the cantilever probe 4, and components at respective frequencies fₘ and 2fₘ.

Note that in the present embodiment, as in the foregoing embodiment, the signal which has the frequency f₁ is inputted from the first phase locked loop circuit 20 to the automatic gain control circuit 24, and the first AC signal which is inputted to a probe control section 10 is generated. Further, the signal which is outputted by the optical sensor 18 is inputted to a second phase locked loop circuit 22 as in the foregoing embodiment. As a result, the second phase locked loop circuit 22 outputs a double frequency signal which has a frequency 2f₁.

It should be noted here that in the present embodiment, the first phase locked loop circuit 20, the second phase locked loop circuit 22, and the automatic gain control circuit 24 each have a phase shifter. This allows each of the first phase locked loop circuit 20, the second phase locked loop circuit 22, and the automatic gain control circuit 24 to convert an inputted signal, for example, from a cosine wave to a sine wave or from a sine wave to a cosine wave sine wave, and output a converted wave.

In the present embodiment, for example, in a case where the signal which is outputted by the optical sensor 18 is a cosine wave, the first phase locked loop circuit 20 outputs, as sine waves, a signal at a frequency f₁ which is to be inputted to the automatic gain control circuit 24 and a comparison signal which is to be inputted to each lock-in amplifier. Further, the second phase locked loop circuit 22 outputs, as a sine wave, the double frequency signal which is to be outputted. Further, the automatic gain control circuit 24 outputs, as a sine wave, a signal which is to be inputted to the probe control section 10. Note that the signal for excitation of the cantilever probe (in other words, the signal which is inputted to the probe control section 10) and a displacement signal of the cantilever probe (in other words, the signal which is outputted by the optical sensor 18) are shifted by n/2 in phase. Therefore, as described above, in a case where the signal inputted to the probe control section 10 is a sine wave, the signal which is outputted by the optical sensor 18 is a cosine wave.

The double frequency signal from the second phase locked loop circuit 22 is also inputted to the second amplitude modulator 70 in addition to the first amplitude modulator 38. Similarly, the reference AC signal from an AC power source 40 is also inputted to the second amplitude modulator 70 in addition to the first amplitude modulator 38. Note that in the present embodiment, the reference AC signal from the AC power source 40 is a sine wave.

The second amplitude modulator 70, unlike the first amplitude modulator 38, outputs a signal which has a frequency that is obtained by subtracting, from frequency of one of those two signals that have been inputted, a frequency of the other one of those two signals. Further, the second amplitude modulator 70 outputs a signal which is in opposite phase from a signal that is outputted by the first amplitude modulator 38. Except for the above, the second amplitude modulator 70 may have the same configuration as the first amplitude modulator 38 and may be an SSB modulator.

In the present embodiment, the first amplitude modulator 38 outputs the first high frequency signal which has the frequency 2f₁+fₘ, and the second amplitude modulator 70 outputs the second high frequency signal which has the frequency 2f₁−fₘ. The first high frequency signal from the first amplitude modulator 38 and the second high frequency signal from the second amplitude modulator 70 are inputted to the adder 72. As a result, the adder 72 outputs, as the second AC signal, a signal in which the first high frequency signal and the second high frequency signal are superimposed on each other. In the present embodiment, as in the foregoing embodiment, the second AC signal is superimposed on the DC signal by an adder 48, and then applied to the sample X via the stage electrode 14.

It should be noted here that both of double frequency signals which are inputted to the first amplitude modulator 38 and the second amplitude modulator 70 each have a sine wave. Therefore, the first high frequency signal which is outputted by the first amplitude modulator 38 and the second high frequency signal which is outputted by the second amplitude modulator 70 each have a sine wave. Meanwhile, the first high frequency signal and the second high frequency signal have opposite phases from each other. Note that one of the first amplitude modulator 38 and the second amplitude modulator 70 may have a phase shifter. Then, one of the first amplitude modulator 38 and the second amplitude modulator 70 may convert a phase(s) of the first high frequency signal and/or the second high frequency signal so that the first high frequency signal and the second high frequency signal are in opposite phases from each other.

Further, in the present embodiment, the measurement signal from the first phase locked loop circuit 20 is also inputted to a double frequency lock-in amplifier 74 in addition to an actual frequency lock-in amplifier 42. Furthermore, the reference AC signal from the AC power source 40 is also inputted to the double frequency lock-in amplifier 74 in addition to the actual frequency lock-in amplifier 42.

The double frequency lock-in amplifier 74 has the same configuration as the actual frequency lock-in amplifier 42 except that: a signal obtained by doubling the frequency of the reference AC signal that has been inputted is used as a reference signal and is compared with a comparison signal. In other words, to the double frequency lock-in amplifier 74, a double frequency reference signal which has a frequency that is twice the frequency of the reference AC signal is inputted. The double frequency lock-in amplifier 74 may have a phase locked loop circuit for doubling the frequency of the reference AC signal that has been inputted. Therefore, the double frequency lock-in amplifier 74 outputs a signal that includes a modulated component Δf(2fₘ), which is a component at the frequency 2fₘ among the components of the frequency shift Δf

The modulated component Δf(2fₘ) represents a slope of a modulated component Δf(fₘ) with respect to a voltage V_{dc} of the DC signal. In other words, the modulated component Δf(2fₘ) corresponds to a first derivative value of the modulated component Δf(fₘ), which is the varying component of the vibration of the cantilever probe 4, with respect to the voltage V_{dc} of the DC signal to be applied to the sample X. To an analyzing section 44, a signal that includes the modulated component Δf(2fₘ) from the double frequency lock-in amplifier 74 is inputted in addition to a signal that includes the modulated component Δf(fₘ) from the actual frequency lock-in amplifier 42.

Therefore, the analyzing section 44 can measure a change in the modulated component Δf(fₘ) relative to a change in a DC component of the signal applied to the sample X, from a value of the modulated component Δf(2fₘ) in a case where a signal having a voltage V_{dc} of a single DC signal is applied to the sample X. In other words, the vibration component measuring device 68 in accordance with the present embodiment does not necessarily apply two DC signals having different voltage values for measuring the change in the modulated component Δf(fₘ) relative to the change in the DC component of the signal which is applied to the sample X.

### <Measuring Device for First Derivative Value of Varying Component: Second Operation>

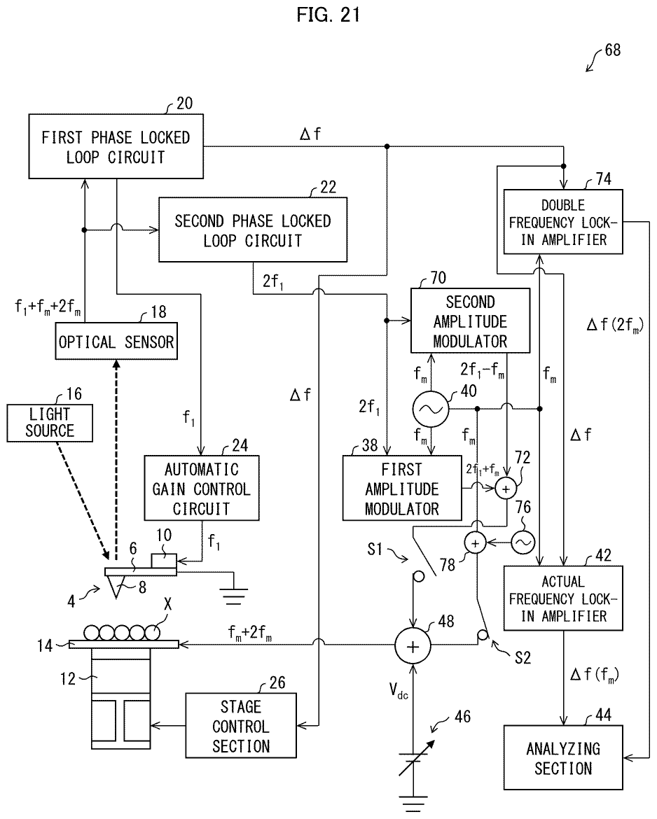

Next, with reference to FIG. 21, the following description will discuss, as a second operation, an operation of the vibration component measuring device 68 in a state in which the first switch S1 is open and the second switch S2 is closed. FIG. 21 is a block diagram for illustrating the second operation of the vibration component measuring device 68 in accordance with the present embodiment.

In the second operation of the vibration component measuring device 68, since the first switch S1 is open, none of signals which are outputted by the first amplitude modulator 38 and the second amplitude modulator 70 is applied to the adder 48. Instead, in the present embodiment, the reference AC signal from the AC power source 40 and a signal from the AC power source 76 are applied to the adder 48.

The AC power source 76 outputs an AC signal having a frequency 2fₘ that is twice the frequency fₘ of the reference AC signal which is outputted by the AC power source 40. Note that the AC signal from the AC power source 76 may be in phase with or in opposite phase from the reference AC signal which is outputted by the AC power source 40. Note that the vibration component measuring device 68 in accordance with the present embodiment may have, in place of the AC power source 76, a doubler that doubles the reference AC signal from the AC power source 40.

In the present embodiment, both of the signal from the AC power source 40 and the signal from the AC power source 76 are inputted to the adder 78. Therefore, the adder 78 outputs a signal in which the reference AC signal having the frequency fₘ and the AC signal having the frequency 2fₘ are superimposed on each other. In the second operation of the vibration component measuring device 68, since the second switch S2 is closed, the signal from the adder 78 is applied to the adder 48 via the second switch S2. Therefore, the adder 48 applies, to the sample X via the stage electrode 14, a signal in which the reference AC signal having the frequency fₘ, the AC signal having the frequency 2fₘ, and the DC signal having the voltage V_{dc} are superimposed on each other.

Thus, in the second operation of the vibration component measuring device 68, the vibration of the cantilever probe 4 has components at a vibration frequency fₘ and a vibration frequency 2fₘ. Therefore, the signal which is outputted by the optical sensor 18 has components at the frequency fₘ and the frequency 2fₘ.

Further, since the cantilever probe 4 vibrates at the vibration frequency f₁, the vibration of the cantilever probe 4 has, at the vibration frequencies f₁+fₘ, f₁+2fₘ, f₁−fₘ, and f₁−2fₘ, side bands of a modulated component. Therefore, as a result of inputting, to the first phase locked loop circuit 20, the signal which is outputted by the optical sensor 18, the first phase locked loop circuit 20 outputs a measurement signal. The measurement signal includes the varying component of the vibration of the cantilever probe 4, and the components at the frequency fₘ and at the frequency 2fₘ.

In the second operation of the vibration component measuring device 68, as in the first operation, the measurement signal from the first phase locked loop circuit 20 is inputted, as a comparison signal, to the actual frequency lock-in amplifier 42 and the double frequency lock-in amplifier 74. Further, in the second operation of the vibration component measuring device 68, as in the first operation, the reference AC signal from the AC power source 40 is inputted, as a reference signal, to the actual frequency lock-in amplifier 42 and the double frequency lock-in amplifier 74. Therefore, in the second operation of the vibration component measuring device 68, as in the first operation, the actual frequency lock-in amplifier 42 outputs a signal which includes the modulated component Δf(fₘ), and the double frequency lock-in amplifier 74 outputs a signal which includes a modulated component Δf(2fₘ).

In the second operation of the vibration component measuring device 68, the signal applied to the sample X has a frequency that is lower than a frequency of the signal applied to the sample X in the first operation of the vibration component measuring device 68. Therefore, the vibration component measuring device 68 can measure a difference between respective modulated components Δf(fₘ) which are obtained in the first operation and the second operation, and a difference between respective modulated components Δf(2fₘ) which are obtained in the first operation and the second operation.

In the present embodiment, as in the foregoing embodiment, the vibration component measuring device 68 can measure a change in the modulated component Δf(fₘ) with respect to a change in the DC component of the signal applied to the sample X, for each of a case where the AC component of the signal applied to the sample X has a low frequency and a case where the AC component of the signal applied to the sample X has a high frequency.

In particular, the vibration component measuring device 68 measures the modulated component Δf(2fₘ), which is a first derivative value of the modulated component Δf(fₘ) that is the varying component of the cantilever probe 4. Therefore, the vibration component measuring device 68 can measure a change in the modulated component Δf(fₘ) relative to a change in the DC component of the signal which is applied to the sample X, without actually changing the DC component of the signal which is applied to the sample X.

The vibration component measuring device 68 in accordance with the present embodiment can simultaneously measure the modulated component Δf(fₘ) and the modulated component Δf(2fₘ) by the actual frequency lock-in amplifier 42 and the double frequency lock-in amplifier 74. However, the vibration component measuring device 68 in accordance with the present embodiment is not limited to this configuration. The vibration component measuring device 68 may include only the double frequency lock-in amplifier 74 among the lock-in amplifiers to which the comparison signal is inputted, and may measure only the modulated component Δf(2fₘ) as the varying component of the cantilever probe 4. In other words, the vibration component measuring device 68 only needs to include at least one lock-in amplifier that calculates the modulated component Δf(fₘ) by comparing the comparison signal with the reference signal.

The vibration component measuring device 68 in accordance with the present embodiment applies, to the sample X, a first high frequency signal and a second high frequency signal which are in opposite phases from each other in the first operation. However, the vibration component measuring device 68 in accordance with the present embodiment is not limited to such a configuration, but may apply, to the sample X, a first high frequency signal and a second high frequency signal which are in phase with each other in the first operation.

For example, in a case where the signal which is outputted by the optical sensor 18 is a cosine wave, the first phase locked loop circuit 20 outputs, as a sine wave, only a signal which has the frequency f₁ and which is to be inputted to the automatic gain control circuit 24, and leaves, as a cosine wave, the comparison signal which is to be inputted to each lock-in amplifier. Further, the second phase locked loop circuit 22 outputs, as a cosine wave, the double frequency signal which is to be outputted. Note that the automatic gain control circuit 24 outputs, as a sine wave, the signal which is to be inputted to the probe control section 10.

In the above configuration, even in a case where the first high frequency signal and the second high frequency signal are in phase with each other, the vibration of the cantilever probe 4 can include, at the vibration frequencies f₁+fₘ, f₁+2fₘ, f₁−fₘ, and f₁−2fₘ, side bands of the modulated component. This allows the vibration component measuring device 68 to measure the modulated component Δf(fₘ) and the modulated component Δf(2fₘ), even in a case where the first high frequency signal and the second high frequency signal are in phase with each other.

In the present embodiment, the first high frequency signal has the frequency 2f₁+fₘ, and the second high frequency signal has the frequency 2f₁−fₘ. However, the present embodiment is not limited to this configuration. As long as the difference in frequency between the first high frequency signal and the second high frequency signal is 2fₘ, the first high frequency signal and the second high frequency signal may have a higher frequency or a lower frequency. For example, the first high frequency signal and the second high frequency signal each may have a frequency in the gigahertz band. In this case, the vibration component measuring device 68 can measure the modulated component Δf(fₘ) and the modulated component Δf(2fₘ) in cases where a signal having a higher frequency or a lower frequency than the second AC signal is applied to the sample X.

### Embodiment 3

### <Integrator>

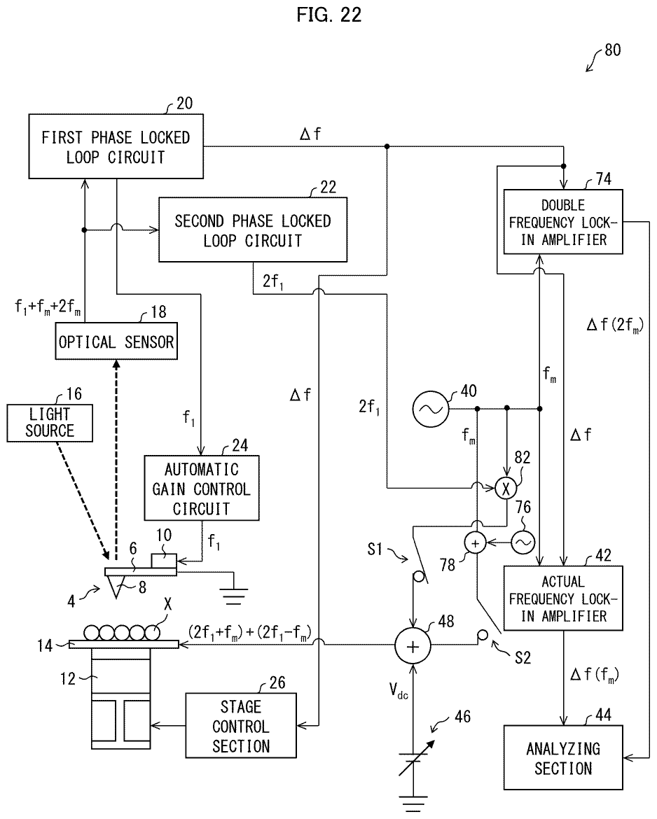

FIG. 22 is a block diagram for illustrating a configuration of a vibration component measuring device 80 in accordance with the present embodiment, and an operation of the vibration component measuring device 80.

The vibration component measuring device 80 in accordance with the present embodiment, as compared with the vibration component measuring device 68, includes an integrator 82 in place of the first amplitude modulator 38, the second amplitude modulator 70, and the adder 72. Except for the above, unless otherwise specifically mentioned, the vibration component measuring device 80 in accordance with the present embodiment has the same configuration as the vibration component measuring device 68. With reference to FIG. 22, the following will discuss, as a first operation, an operation of the vibration component measuring device 80 in a state in which a first switch S1 is closed and a second switch S2 is open.

In the first operation of the vibration component measuring device 80 in accordance with the present embodiment, a double frequency signal from a second phase locked loop circuit 22 and a reference AC signal from an AC power source 40 are inputted to the integrator 82. The integrator 82 outputs a signal obtained by integrating a plurality of signals which have been inputted. Therefore, the integrator 82 in accordance with the present embodiment outputs a signal obtained by superimposing the following signals: (a) a signal obtained by adding up a frequency 2f₁ of the double frequency signal and a frequency fₘ of the reference AC signal; and (b) a signal obtained by subtracting the frequency fₘ of the reference AC signal from the frequency 2f₁ of the double frequency signal. In other words, the integrator 82 outputs, as a second AC signal, a signal in which a first high frequency signal and a second high frequency signal which are in phase with each other are superimposed on each other, as described in the foregoing embodiment.

The second AC signal from the integrator 82 is inputted to an adder 48 via the first switch S1. Therefore, in the first operation of the vibration component measuring device 80 in accordance with the present embodiment, as in the foregoing embodiment, a signal in which the second AC signal and a DC signal which has a voltage V_{dc} are superimposed on each other is applied.

In the present embodiment, a signal having a frequency f₁ which is outputted by the first phase locked loop circuit 20 is a sine wave. Further, a comparison signal which is outputted by the first phase locked loop circuit 20 and the double frequency signal having the frequency 2f₁ which is outputted by the second phase locked loop circuit 22 are cosine waves. Therefore, as described in the foregoing embodiment, the vibration component measuring device 80 in accordance with the present embodiment can measure a modulated component Δf(fₘ) and a modulated component Δf(2fₘ). Note that a second operation of the vibration component measuring device 80 in accordance with the present embodiment is carried out by the same method as the second operation of the vibration component measuring device 68.

In the present embodiment, as in the foregoing embodiment, the vibration component measuring device 80 can measure a change in the modulated component Δf(fₘ) and a value of the modulated component Δf(2fₘ), for each of a case where an AC component of a signal applied to a sample X has a low frequency and a case where the AC component of the signal applied to the sample X has a high frequency. Furthermore, unlike the vibration component measuring device in accordance with each of the foregoing embodiments, the vibration component measuring device 80 does not require an amplitude modulator. Therefore, the vibration component measuring device 80 can measure, with a simpler configuration, the change in the modulated component Δf(fₘ) and the value of the modulated component Δf(2fₘ).

### Embodiment 4

### <Measuring Device for Second Derivative Value of Varying Component>

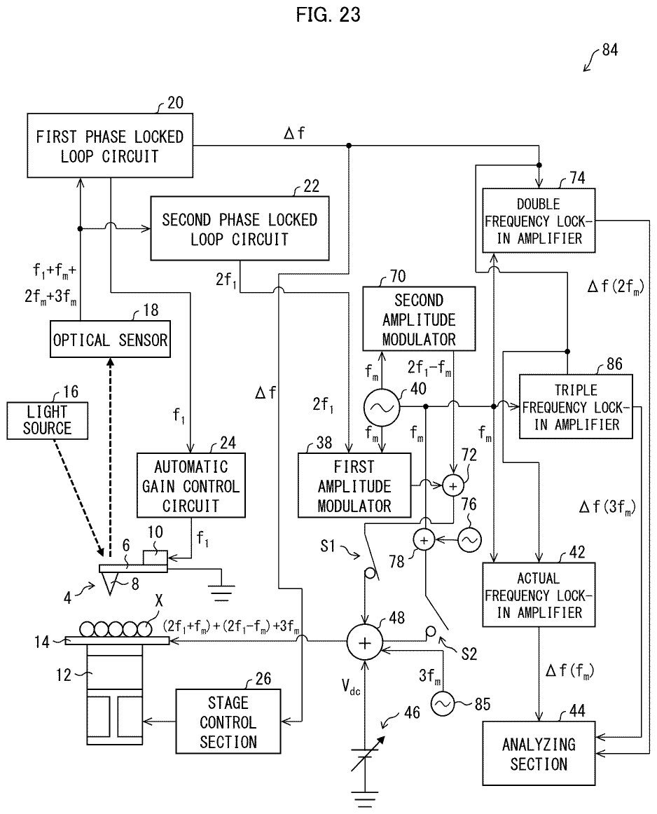

FIG. 23 is a block diagram for illustrating a configuration of a vibration component measuring device 84 in accordance with the present embodiment, and an operation of the vibration component measuring device 84.

The vibration component measuring device 84 in accordance with the present embodiment further includes, in the vibration component measuring device 68, an AC power source 85 and a triple frequency lock-in amplifier 86. Except for the above, unless otherwise specifically mentioned, the vibration component measuring device 84 in accordance with the present embodiment has the same configuration as the vibration component measuring device 68. With reference to FIG. 23, the following will discuss, as a first operation, an operation of the vibration component measuring device 84 in a state in which a first switch S1 is closed and a second switch S2 is open.

The AC power source 85 generates an AC signal which has a frequency 3fₘ. Further, a signal from the AC power source 85 is always inputted to an adder 48. Therefore, in the present embodiment, a signal in which a first high frequency signal, a second high frequency signal, and a DC signal, and in addition, an AC signal which has a frequency 3fₘ are superimposed on each other is inputted from the adder 48 to a sample via a stage electrode 14. Therefore, vibration of a cantilever probe 4 also has, at a vibration frequency f₁+3fₘ and a vibration frequency f₁-3fₘ, side bands of a modulated component. A first phase locked loop circuit 20 therefore outputs a measurement signal, which includes a varying component of the vibration of the cantilever probe 4, and components at a frequency fₘ, a frequency 2fₘ, and a frequency 3fₘ.

In the present embodiment, the measurement signal from the first phase locked loop circuit 20 is inputted to the actual frequency lock-in amplifier 42 and the double frequency lock-in amplifier 74, and in addition, inputted also to the triple frequency lock-in amplifier 86. Furthermore, a reference AC signal from an AC power source 40 is inputted to the actual frequency lock-in amplifier 42 and the double frequency lock-in amplifier 74, and in addition, inputted also to the triple frequency lock-in amplifier 86.

The triple frequency lock-in amplifier 86 has the same configuration as the actual frequency lock-in amplifier 42 except that: a signal which has a frequency obtained by tripling a frequency of the reference AC signal that has been inputted is used as a reference signal and is compared with a comparison signal. In other words, to the triple frequency lock-in amplifier 86, a triple frequency reference signal which has a frequency that is three times the frequency of the reference AC signal is inputted. The triple frequency lock-in amplifier 86 may have a phase locked loop circuit for tripling the frequency of the reference AC signal that has been inputted. Therefore, the triple frequency lock-in amplifier 86 outputs a signal that includes a modulated component Δf(3fₘ), which is a component at the frequency 3fₘ among components of a frequency shift Δf.

Except for the above, the first operation and a second operation of the vibration component measuring device 84 in accordance with the present embodiment are carried out in the same manner as the first operation and the second operation of the vibration component measuring device 68, respectively.

In the present embodiment, the vibration component measuring device 84 can measure a value of the modulated component Δf(3fₘ) in addition to a modulated component Δf(fₘ) and a modulated component Δf(2fₘ). The modulated component Δf(3fₘ) represents a slope of the modulated component Δf(2fₘ) with respect to a voltage V_{dc} of the DC signal. In other words, the modulated component Δf(3fₘ) corresponds to a second derivative value of the modulated component Δf(fₘ), which is the varying component of the vibration of the cantilever probe 4, with respect to the voltage V_{dc} of the DC signal to be applied to a sample X. To an analyzing section 44, in addition to a signal that includes the modulated component Δf(fₘ) from the actual frequency lock-in amplifier 42 and the modulated component Δf(2fₘ) from the double frequency lock-in amplifier 74, a signal that includes the modulated component Δf(3fₘ) from the triple frequency lock-in amplifier 86 is inputted.

As described above, a state of a surface of the sample X varies depending on the voltage V_{dc} of the DC signal which is applied to the sample X. In a case where the state of the surface of the sample X changes, a slope of the modulated component Δf(fₘ) changes, as illustrated in FIG. 14. In other words, in a case where the state of the surface of the sample X changes, the modulated component Δf(2fₘ) changes.

It is assumed here that, for example, the value of the modulated component Δf(3fₘ) is measured while the voltage V_{dc} of the DC signal applied to the sample X is being changed. In this case, when the voltage V_{dc} at which the state of the surface of the sample X changes is applied, the value of the modulated component Δf(3fₘ) changes. Therefore, the vibration component measuring device 84 in accordance with the present embodiment can measure a change of the state of the surface or an interface of the sample X by measuring the value of the modulated component Δf(3fₘ).

Furthermore, in a case where measurement is carried out by the vibration component measuring device 84 while a position where the measurement is made on the surface of the sample X is being changed, a polarity of a charge at the position may change depending on the position on the surface of the sample X. The modulated component Δf(3fₘ) that is measured in such a case changes. Therefore, the vibration component measuring device 84 can measure, by measuring the modulated component Δf(3fₘ), the polarity of a surface charge of the sample X at the position where measurement is made.

### Embodiment 5

### <Simultaneous Application of Low Frequency and High Frequency>

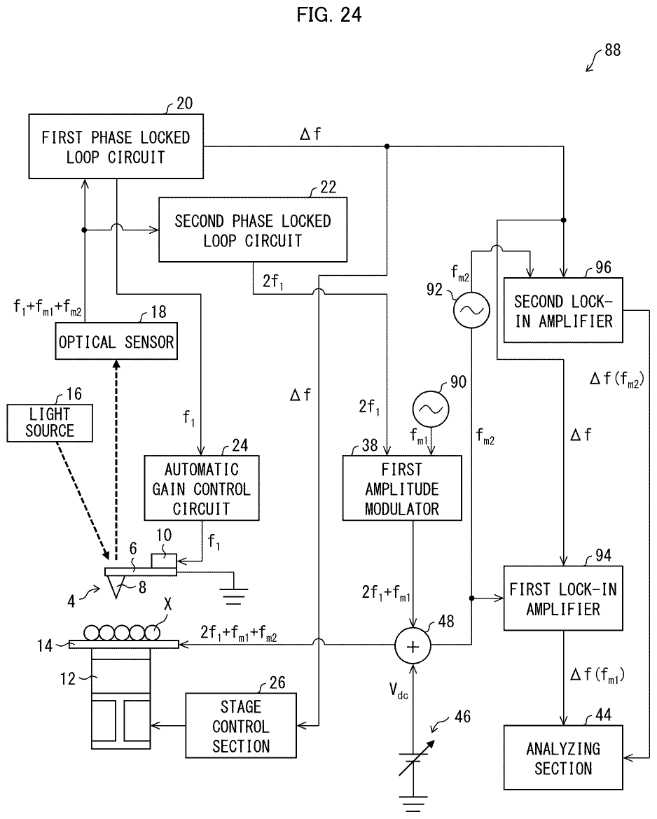

FIG. 24 is a block diagram for illustrating a configuration of a vibration component measuring device 88 in accordance with the present embodiment and an operation of the vibration component measuring device 88.

The vibration component measuring device 88 in accordance with the present embodiment, as compared with the vibration component measuring device 2, includes an AC power source 90 and an AC power source 92 in place of the AC power source 40. Further, the vibration component measuring device 88 in accordance with the present embodiment, as compared with the vibration component measuring device 2, includes a first lock-in amplifier 94 and a second lock-in amplifier 96 in place of the actual frequency lock-in amplifier 42. In addition, unlike the vibration component measuring device 2, the vibration component measuring device 88 in accordance with the present embodiment includes neither a first switches S1 nor a second switches S2. Except for the above, unless otherwise specifically mentioned, the vibration component measuring device 88 in accordance with the present embodiment has the same configuration as the vibration component measuring device 2.

The AC power source 90 generates, as a first reference AC signal, an AC signal which has a frequency fₘ₁, and the AC power source 92 generates, as a second reference AC signal, an AC signal which has a frequency fₘ₂. It should be noted here that both of the frequency fₘ₁ and the frequency fₘ₂ are lower than a frequency f₁. Further, the frequency fₘ₂ of the second reference AC signal differs from an integral multiple of the frequency fₘ₁ of the first reference AC signal. In the present embodiment, the AC power source 90 and the AC power source 92 are reference AC signal generators that generate, as reference AC signals, the first reference AC signal and the second reference AC signal, respectively.

The first lock-in amplifier 94 and the second lock-in amplifier 96 each have the same configuration as, for example, the actual frequency lock-in amplifier 42.

In the operation of the vibration component measuring device 88 in accordance with the present embodiment, a double frequency signal from a second phase locked loop circuit 22 and the first reference AC signal from the AC power source 90 are inputted to a first amplitude modulator 38. Therefore, the first amplitude modulator 38 generates, as a second AC signal, an AC signal which has a frequency 2f₁+fₘ₁ and which is obtained by adding up a frequency of the double frequency signal and the frequency of the first reference AC signal.

In the present embodiment, while the vibration component measuring device 88 is being operated, the second AC signal from the first amplitude modulator 38 is always applied to the adder 48.

In the operation of the vibration component measuring device 88 in accordance with the present embodiment, further, the second reference AC signal from the AC power source 92 is always applied to the adder 48. Therefore, in the present embodiment, while the vibration component measuring device 88 is operating, the adder 48 outputs, at all times, a signal in which the second AC signal having the frequency 2f₁+fₘ₁ and the second reference AC signal having the frequency fₘ₂ are superimposed on each other. Note that in the adder 48, a DC signal from a DC power source 46 is further superimposed. Therefore, the adder 48 applies, to a sample X via a stage electrode 14, a signal in which the second AC signal, the second reference AC signal, and the DC signal having a voltage V_{dc} are superimposed on each other.

Thus, in the operation of the vibration component measuring device 88, vibration of a cantilever probe 4 always has components at a vibration frequency fₘ₁ and a vibration frequency fₘ₂. Therefore, a signal which is outputted by the optical sensor 18 always has components at the frequency fₘ₁ and the frequency fₘ₂.

Further, the cantilever probe 4 vibrates at a vibration frequency f₁. It should be noted here that the vibration of the cantilever probe 4 has, at the vibration frequency f₁+fₘ and a vibration frequency 3f₁+fₘ, side bands of a modulated component due to the second AC signal which has a high frequency. At the same time, the vibration of the cantilever probe 4 has, at the vibration frequency f₁+fₘ₂ and a vibration frequency f₁−fₘ₂, side bands of a modulated component due to the second reference AC signal which has a low frequency.

Therefore, the first phase locked loop circuit 20 to which the signal from the optical sensor 18 is inputted outputs a comparison signal which includes both of a component that has a frequency shift Δf due to the second AC signal and a component which has a frequency shift Δf due to the second reference AC signal.

To the first lock-in amplifier 94, the first reference AC signal which has the frequency fₘ₁ is applied as a first reference signal. Meanwhile, to the second lock-in amplifier 96, the second reference AC signal which has the frequency fₘ₂ is applied as a second reference signal. Therefore, the first lock-in amplifier 94 outputs a signal that includes a modulated component Δf(fₘ₁), which includes a component of the frequency shift Δf due to the AC signal having the frequency 2f₁+fₘ₁. Meanwhile, the second lock-in amplifier 96 outputs a signal that includes a modulated component Δf(fₘ₂), which includes a component of a frequency shift Δf due to the AC signal having the frequency fₘ₂. Both of the signals from the first lock-in amplifier 94 and the second lock-in amplifier 96 are inputted to an analyzing section 44.

The vibration component measuring device 88 thus measures the modulated component Δf(fₘ₁) as a varying component of the vibration of the cantilever probe 4 that is caused by the second AC signal. Further, the vibration component measuring device 88 measures the modulated component Δf(fₘ₂) as a varying component of the vibration of the cantilever probe 4 that is caused by the second reference AC signal, which is a reference AC signal. Furthermore, the vibration component measuring device 88 can simultaneously measure the modulated component Δf(fₘ₁) and the modulated component Δf(fₘ₂).

Therefore, the vibration component measuring device 88 in accordance with the present embodiment can simultaneously measure respective changes in varying components of the vibration of the cantilever probe 4, for a case where an AC component of the signal applied to the sample X has a low frequency and a case where an AC component of the signal applied to the sample X has a high frequency. This allows the vibration component measuring device 88 to more easily measure the changes in the above-described varying components relative to changes in frequency of the AC components of the signal which is applied to the sample X.

In the present embodiment, both of the first lock-in amplifier 94 and the second lock-in amplifier 96 have the same configuration as the actual frequency lock-in amplifier 42. However, the present embodiment is not limited to such a configuration. The vibration component measuring device 88 in accordance with the present embodiment may have the same configuration as the double frequency lock-in amplifier 74, and may further include two lock-in amplifiers to which the first reference AC signal and the second reference AC signal are applied as reference signals, respectively. The vibration component measuring device 88 may thus simultaneously measure a modulated component Δf(2fₘ₁) and a modulated component Δf(2fₘ₂). The above allows the vibration component measuring device 88 to measure changes in the modulated component Δf(2fₘ₁) and the modulated component Δf(2fₘ₂) described above, without the need to apply, to the sample X, a plurality of DC signals which have voltages V_{dc}.

### Embodiment 6

### <Measurement of Amplitude Shift>

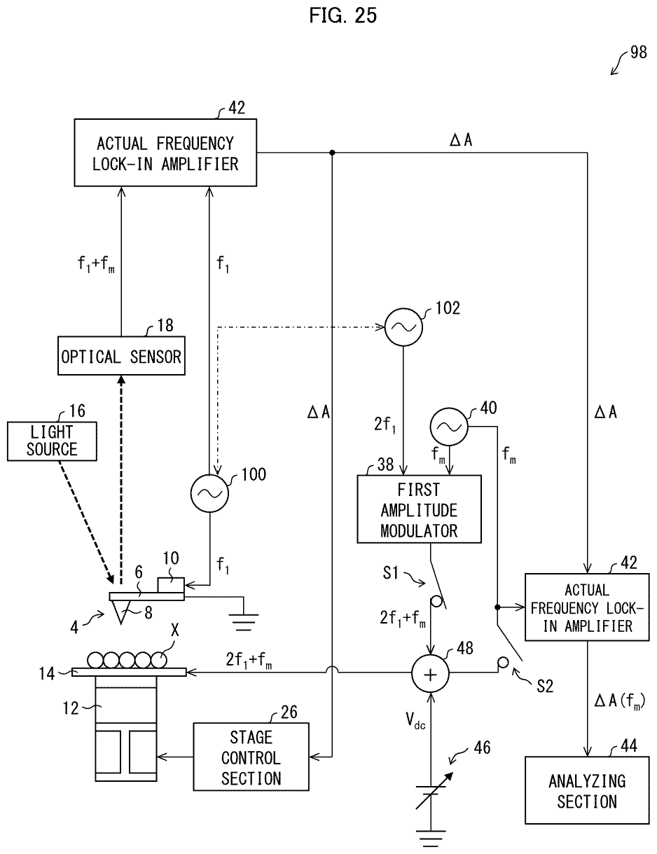

FIG. 25 is a block diagram for illustrating configuration of a vibration component measuring device 98 in accordance with the present embodiment, and an operation of the vibration component measuring device 98.

The vibration component measuring device 98 in accordance with the present embodiment, unlike the vibration component measuring device 2, does not include the first phase locked loop circuit 20, the second phase locked loop circuit 22, or the automatic gain control circuit 24. In place of these circuits, the vibration component measuring device 98 in accordance with the present embodiment additionally includes another actual frequency lock-in amplifier 42, and also includes an AC power source 100 and an AC power source 102.

Except for the above, unless otherwise specifically mentioned, the vibration component measuring device 98 in accordance with the present embodiment has the same configuration as the vibration component measuring device 2. With reference to FIG. 25, the following will discuss, as a first operation, an operation of the vibration component measuring device 98 in a state in which a first switch S1 is closed and a second switch S2 is open.

The AC power source 100 generates a first AC signal which has a frequency f₁, and inputs this signal to a probe control section 10. Therefore, the AC power source 100 is a first AC signal generator that generates the first AC signal for causing a cantilever probe 4 to vibrate. The AC power source 102 generates a double frequency signal which has a frequency 2f₁, and inputs the double frequency signal to a first amplitude modulator 38.

Since a reference AC signal from an AC power source 40 is also applied to the first amplitude modulator 38, the first amplitude modulator 38 outputs a second AC signal which has a frequency 2f₁+fₘ. Therefore, in the first operation of the vibration component measuring device 98 in accordance with the present embodiment, as in the foregoing embodiment, a signal in which the second AC signal and the DC signal having the voltage V_{dc} are superimposed on each other is applied to the sample X.

Vibration of the cantilever probe 4 thus has, at a vibration frequency f₁+fₘ and a vibration frequency 3f₁+fₘ, side bands of a modulated component. Therefore, a signal which is outputted by an optical sensor 18 also has components at a frequency f₁+fₘ and a frequency 3f₁+fₘ.

It should be noted here that the AC power source 102 is synchronous with the AC power source 100 so that the double frequency signal which is outputted is in phase with the first AC signal which is outputted by the AC power source 100. Therefore, strength of the side bands of the measurement signal which is outputted by the optical sensor 18 has a correlation with magnitude of an amplitude shift AA of the vibration of the cantilever probe 4 which is caused by an interaction between the cantilever probe 4 and a sample X.

The measurement signal which is outputted by the optical sensor 18 is inputted to one of the actual frequency lock-in amplifiers 42. The first AC signal from the AC power source 100 is inputted, as a reference signal, to this actual frequency lock-in amplifier 42. The one actual frequency lock-in amplifier 42 thus outputs a comparison signal which includes a component of the amplitude shift AA of the cantilever probe 4, by comparing the measurement signal from the optical sensor 18 with the first AC signal.

The comparison signal is inputted to the other one of the actual frequency lock-in amplifiers 42. The other actual frequency lock-in amplifier 42 receives, as a reference signal, the reference AC signal from the AC power source 40. As a result, the other actual frequency lock-in amplifier 42 outputs a signal which includes, as a varying component of the vibration of the cantilever probe 4 that is a vibration section, a modulated component ΔA(fₘ) that is a component at a frequency fₘ among components of the amplitude shift ΔA.

The signal that includes the modulated component ΔA(fₘ) and that is outputted by the actual frequency lock-in amplifier 42 to which the comparison signal is inputted is inputted to an analyzing section 44. The analyzing section 44 measures the modulated component ΔA(fₘ). The analyzing section 44 then calculates, from the modulated component ΔA(fₘ) that is measured for each voltage V_{dc}, an electric capacitance between an interface of the sample X and the cantilever probe 4. This calculation of the electric capacitance between the interface of the sample X and the cantilever probe 4 from the modulated component ΔA(fₘ) can be carried out similarly to the calculation of the electric capacitance between the interface of the sample X and the cantilever probe 4 from the modulated component Δf(fₘ).

The vibration component measuring device 98 measures the modulated component ΔA(fₘ), for example, while changing the voltage V_{dc}. More specifically, the vibration component measuring device 98 measures respective modulated components Δf(fₘ) in cases where DC signals applied to the sample X are the first DC signal and the second DC signal which have respective different values of the voltage V_{dc}.

In the second operation of the operation of the vibration component measuring device 98, the first switch S1 is closed and the second switch S2 is open. Therefore, in the second operation of the vibration component measuring device 98, a signal in which the reference AC signal from the AC power source 40 and the DC signal that has the voltage V_{dc} are superimposed on each other in the adder 48 is applied to the sample X.

The vibration of the cantilever probe 4 thus has, at the vibration frequency f₁+fₘ and the vibration frequency f₁−fₘ, side bands of a modulated component. Therefore, the signal which is outputted by an optical sensor 18 also has components at the frequency f₁+fₘ and the frequency f₁−fₘ.

It should be noted here that the AC power source 40 is synchronous with the AC power source 100 so that the reference AC signal which is outputted is in phase with the first AC signal which is outputted by the AC power source 100. Therefore, the strength of the side bands of the measurement signal which is outputted by the optical sensor 18 has a correlation with the amplitude of the amplitude shift ΔA of the cantilever probe 4 which is caused by the interaction between the cantilever probe 4 and the sample X. The actual frequency lock-in amplifier 42 to which the measurement signal from the optical sensor 18 is applied thus outputs a comparison signal which includes the component of the amplitude shift ΔA of the cantilever probe 4.

Therefore, in a second operation of the operation of the vibration component measuring device 98, as in the first operation, the actual frequency lock-in amplifier 42 to which the comparison signal is inputted outputs a signal that includes a modulated component ΔA(fₘ) which is a component at the frequency fₘ among components of the amplitude shift ΔA. Further, the analyzing section 44 calculates, from the modulated component ΔA(fₘ) that is measured for each voltage V_{dc}, an electric capacitance between the interface of the sample X and the cantilever probe 4. As described above, the vibration component measuring device 98 measures a difference between the modulated components ΔA(fₘ) that are obtained in the first operation and the second operation, respectively.

The vibration component measuring device 98 in accordance with the present embodiment, as compared with the vibration component measuring device 2, can measure the modulated component ΔA(fₘ) in place of the modulated component Δf(fₘ), as a varying component of the vibration of the cantilever probe 4. In the present embodiment, as in the foregoing embodiment, the vibration component measuring device 98 can more efficiently measure a change in a varying component of the vibration section, and thus can more efficiently calculate the interface state density of the sample X.

### Embodiment 7

### <Measurement of Phase Shift>

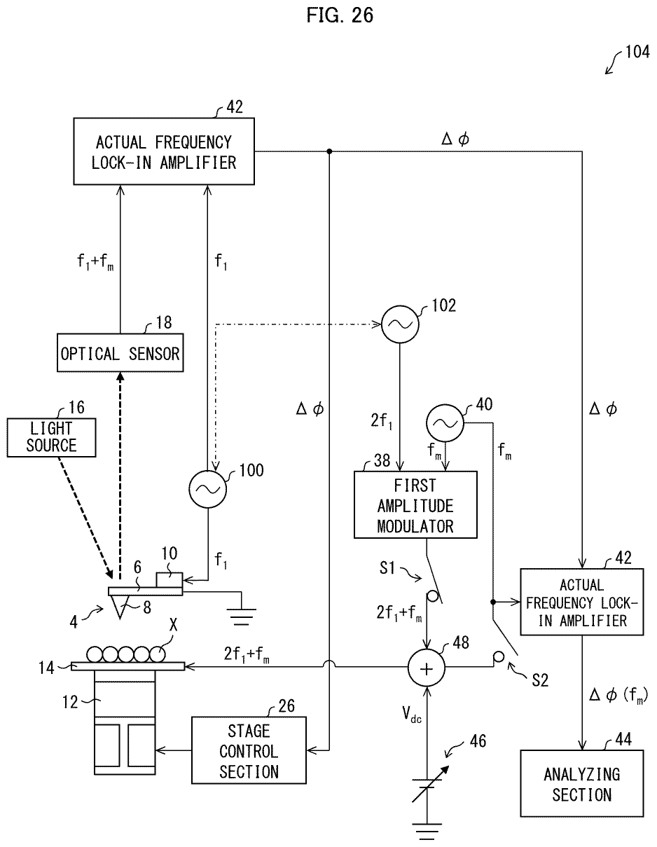

FIG. 26 is a block diagram for illustrating a configuration of a vibration component measuring device 104 in accordance with the present embodiment and an operation of the vibration component measuring device 104.

The vibration component measuring device 104 in accordance with the present embodiment has the same configuration as the vibration component measuring device 98. With reference to FIG. 26, the following will discuss, as a first operation, an operation of the vibration component measuring device 104 in a state in which a first switch S1 is closed and a second switch S2 is open.

In the first operation of the vibration component measuring device 104 in accordance with the present embodiment, as in the foregoing embodiment, a signal in which a second AC signal and a DC signal having a voltage V_{dc} are superimposed on each other is applied to a sample X. Vibration of a cantilever probe 4 thus has, at a vibration frequency f₁+fₘ and a vibration frequency 3f₁+fₘ, side bands of a modulated component. Therefore, a signal which is outputted by an optical sensor 18 also has components at a frequency f₁+fₘ and a frequency 3f₁+fₘ.

It should be noted here that an AC power source 102 is synchronous with an AC power source 100 so that a double frequency signal which is outputted is in phase with a first AC signal which is outputted by an AC power source 100. Therefore, strength of the side bands of a measurement signal which is outputted by the optical sensor 18 has a correlation with a magnitude of a phase shift Ap of the vibration of the cantilever probe 4 which is caused by an interaction between the cantilever probe 4 and the sample X.

The measurement signal which is outputted by the optical sensor 18 is inputted to one of actual frequency lock-in amplifiers 42. The one actual frequency lock-in amplifier 42 thus outputs a comparison signal which includes a component of the amplitude shift Ao of the cantilever probe 4, by comparing the measurement signal from the optical sensor 18 with the signal from the AC power source 100.

The comparison signal is inputted to the other one of the actual frequency lock-in amplifiers 42. The other actual frequency lock-in amplifier 42 receives, as a reference signal, a reference AC signal from an AC power source 40. The actual frequency lock-in amplifier 42 thus outputs a signal which includes, as the varying component of the vibration of the cantilever probe 4 that is a vibration section, a modulated component Δφ(fₘ) which is a component at a frequency fₘ among components of the phase shift Δφ.

The signal that includes the modulated component Δφ(fₘ) and that is outputted by the actual frequency lock-in amplifier 42 to which the comparison signal is inputted is inputted to an analyzing section 44. The analyzing section 44 measures the modulated component Δφ(fₘ). The analyzing section 44 then calculates, from the modulated component Δφ(fₘ) that is measured for each voltage V_{dc}, an electric capacitance between an interface of the sample X and the cantilever probe 4. This calculation of the electric capacitance between the interface of the sample X and the cantilever probe 4 from the modulated component Δφ(fₘ) can be carried out similarly to the calculation of the electric capacitance between the interface of the sample X and the cantilever probe 4 from the modulated component Δf(fₘ).

The vibration component measuring device 104 measures the modulated component Δφ(fₘ), for example, while changing the value of the voltage V_{dc}. More specifically, the vibration component measuring device 104 measures respective modulated components Δφ(fₘ) in cases where DC signals applied to the sample X are the first DC signal and the second DC signal which have respective different values of the voltage V_{dc}.

In a second operation of the operation of the vibration component measuring device 104, the first switch S1 is closed and the second switch S2 is open. Therefore, in the second operation of the vibration component measuring device 104, a signal in which the reference AC signal from the AC power source 40 and the DC signal that has the voltage V_{dc} are superimposed on each other in the adder 48 is applied to the sample X.

The vibration of the cantilever probe 4 thus has, at the vibration frequency f₁+fₘ and the vibration frequency f₁−fₘ, side bands of a modulated component. Therefore, the signal which is outputted by the optical sensor 18 also has components at the frequency f₁+fₘ and the frequency f₁−fₘ.

It should be noted here that the AC power source 40 is synchronous with the AC power source 100 so that the reference AC signal which is outputted is in phase with the first AC signal which is outputted by the AC power source 100. Therefore, the strength of the side bands of the measurement signal which is outputted by the optical sensor 18 has a correlation with the magnitude of the phase shift Δφ of the cantilever probe 4 which is caused by the interaction between the cantilever probe 4 and the sample X. A first phase locked loop circuit 20 thus outputs a comparison signal which includes a component of the phase shift Δφ of the cantilever probe 4.

Therefore, in the second operation of the operation of the vibration component measuring device 104, as in the first operation, the actual frequency lock-in amplifier 42 to which the comparison signal is inputted outputs a signal that includes a modulated component Δφ(fₘ) which is a component at the frequency fₘ among components of the amplitude shift Δφ. Further, the analyzing section 44 calculates, from the modulated component Δφ(fₘ) that is measured for each voltage V_{dc}, an electric capacitance between the interface of the sample X and the cantilever probe 4. As described above, the vibration component measuring device 104 measures a difference between the modulated components Δφ(fₘ) that are obtained in the first operation and the second operation, respectively.

The vibration component measuring device 104 in accordance with the present embodiment, as compared with the vibration component measuring device 2, can measure the modulated component Δφ(fₘ) in place of the modulated component Δf(fₘ), as a varying component of the vibration of the cantilever probe 4. In the present embodiment, as in the foregoing embodiment, the vibration component measuring device 104 can more efficiently measure a change in a varying component of the vibration section, and thus can more efficiently calculate the interface state density of the sample X.

### Embodiment 8

### <Increasing Speed of Measurement in Lock-In Amplifier>

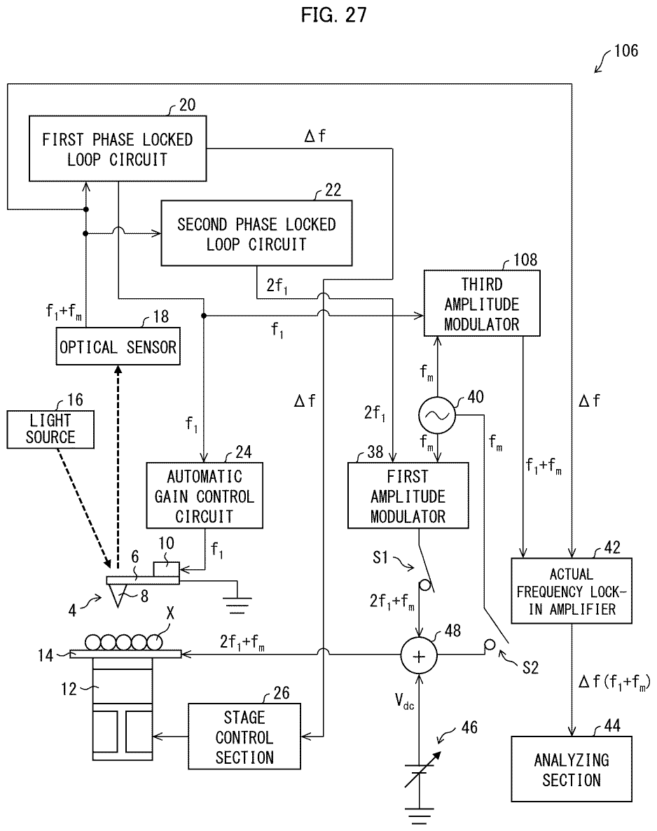

FIG. 27 is a block diagram for illustrating a configuration of a vibration component measuring device 106 in accordance with the present embodiment and an operation of the vibration component measuring device 106.

The vibration component measuring device 106 in accordance with the present embodiment further includes, in the vibration component measuring device 2, a third amplitude modulator 108. Except for the above, unless otherwise specifically mentioned, the vibration component measuring device 106 in accordance with the present embodiment has the same configuration as the vibration component measuring device 2. With reference to FIG. 27, the following will discuss, as a first operation, an operation of the vibration component measuring device 106 in a state in which a first switch S1 is closed and a second switch S2 is open.

In the present embodiment, the third amplitude modulator 108 may have the same configuration as the first amplitude modulator 38 or the second amplitude modulator 70 described above, or may be an SSB modulator. To the third amplitude modulator 108, a signal having a frequency f₁ from a first phase locked loop circuit 20 and a reference AC signal having a frequency fₘ from an AC power source 40 are inputted. In the present embodiment, the third amplitude modulator 108 outputs a signal which has a frequency obtained by adding up frequencies of signals that have been inputted, and specifically, outputs a signal which has a frequency f₁+fₘ.

The signal which is outputted by the third amplitude modulator 108 is inputted, as a reference signal, to an actual frequency lock-in amplifier 42. Furthermore, in the present embodiment, a signal from an optical sensor 18 is inputted, as a comparison signal, to the actual frequency lock-in amplifier 42. The signal which is inputted to the actual frequency lock-in amplifier 42 from the optical sensor 18 may pass through, for example, a band-pass filter which transmits only a frequency component in the vicinity of the frequency f₁+fₘ.

Note that in the first operation of the vibration component measuring device 106 in accordance with the present embodiment, as in the foregoing embodiment, a signal in which a second AC signal having a frequency 2f₁ +fₘ from the first amplitude modulator 38 and a DC signal having a voltage V_{dc} are superimposed on each other is applied to a sample X. Therefore, in the first operation of the vibration component measuring device 106, as in the foregoing embodiment, a measurement signal which is outputted by the optical sensor 18 includes, in a side band at the frequency f₁+fₘ, a component of a frequency shift Δf.

Therefore, the actual frequency lock-in amplifier 42 compares (a) the comparison signal which includes, at the frequency f₁+fₘ, a component of the frequency shift Δf and (b) a reference signal which has the frequency f₁+fₘ. The actual frequency lock-in amplifier 42 thus outputs a signal which includes, as the varying component of the vibration of the cantilever probe 4 that is a vibration section, a modulated component Δf(f₁+fₘ) which is a component at the frequency f₁+fₘ among components of the frequency shift Δf, and inputs the signal to an analyzing section 44.

The analyzing section 44 measures the modulated component Δf(f₁+fₘ). Then, the analyzing section 44 calculates, by a technique that was described above, an electric capacitance between the interface of the sample X and the cantilever probe 4 from the modulated component Δf(f₁+fₘ) that has been measured for each voltage V_{dc} of the DC signal which is applied to the sample X. This calculation of the electric capacitance between the interface of the sample X and the cantilever probe 4 from the modulated component Δf(f₁+fₘ) can be carried out similarly to the calculation of the electric capacitance between the interface of the sample X and the cantilever probe 4 from the modulated component Δf(fₘ).

The vibration component measuring device 106 measures the modulated component Δf(f₁+fₘ), for example, while changing the value of the voltage V_{dc}. More specifically, the vibration component measuring device 106 measures respective modulated components Δf(f₁+fₘ) in cases where DC signals applied to the sample X are a first DC signal and a second DC signal which have respective different values of the voltage V_{dc}.

In a second operation of the vibration component measuring device 106 in accordance with the present embodiment, the first switch S1 is open and the second switch S2 is closed. Accordingly, a signal in which the reference AC signal having the frequency fₘ from the AC power source 40 and the DC signal having the having the voltage V_{dc} are superimposed on each other is applied to the sample X. Therefore, in the second operation of the vibration component measuring device 106, as in the first operation, a measurement signal which is outputted by the optical sensor 18 includes, in a side band at the frequency f₁+fₘ, a component of the frequency shift Δf.

Thus, in the second operation of the vibration component measuring device 106, as in the first operation, the actual frequency lock-in amplifier 42 outputs a signal which includes, as a varying component of the vibration of the cantilever probe 4 that is a vibration section, a modulated component Δf(f₁+fₘ), and inputs the signal to the analyzing section 44. As described above, the vibration component measuring device 106 measures a difference between the modulated components Δf(f₁+fₘ) that are obtained in the first operation and the second operation, respectively.

The vibration component measuring device 106 in accordance with the present embodiment, as compared with the vibration component measuring device 2, can measure the modulated component Δf(f₁+fₘ) in place of the modulated component Δf(fₘ), as a varying component of the vibration of the cantilever probe 4. In the present embodiment, as in the foregoing embodiment, the vibration component measuring device 106 can more efficiently measure a change in a varying component of the vibration section, and thus can more efficiently calculate the interface state density of the sample X.

In addition, in each operation of the vibration component measuring device 106 in accordance with the present embodiment, the frequency of the reference signal which is inputted to the actual frequency lock-in amplifier 42 is higher than the frequency of the reference signal which is inputted to the actual frequency lock-in amplifier 42 in the above-described embodiments. Therefore, the actual frequency lock-in amplifier 42 in accordance with the present embodiment can more quickly generate a signal which includes the modulated component Δf(f₁+fₘ), and ultimately improve speed of measurement of the sample X.

### Embodiment 9

<Vibration Component Measuring Device that Includes Micro-Vibration Mechanism>

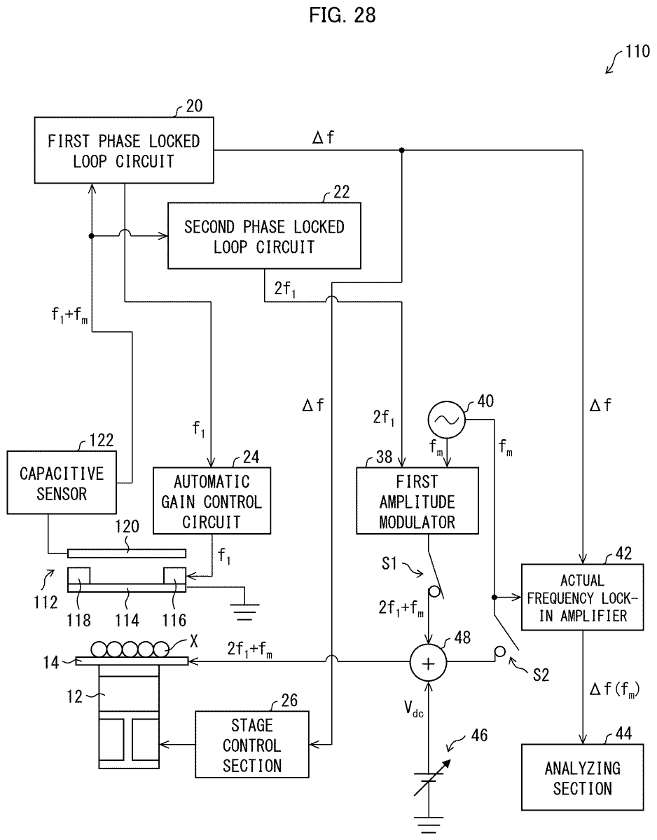

FIG. 28 is a block diagram for illustrating a configuration of a vibration component measuring device 110 in accordance with the present embodiment, and an operation of the vibration component measuring device 110.

The vibration component measuring device 110 in accordance with the present embodiment differs in configuration from the vibration component measuring device 2 in that the vibration component measuring device 110 includes a micro-vibration detection mechanism 112, in place of a cantilever probe 4, a probe control section 10, a light source 16, and an optical sensor 18. The micro-vibration detection mechanism 112 includes a plate spring 114, a plate spring control section 116, a plate spring holding section 118, a fixed electrode 120, and a capacitive sensor 122.

The micro-vibration detection mechanism 112 includes the plate spring 114 as a vibration section. The plate spring 114 is a thin plate-like member that contains, for example, silicon or a silicon oxide film. Since the plate spring 114 is made of silicon or a silicon oxide film, fine processing of the plate spring 114 is easily carried out in production of the plate spring 114. The plate spring 114 may have a metal coating.

The plate spring 114 vibrates under the control of the plate spring control section 116 that serves as a vibration control section. For example, the plate spring control section 116 causes the plate spring 114 to vibrate at a vibration frequency that corresponds to a frequency of applied voltage. Specifically, in a case where there is no interaction between the plate spring 114 and a sample X and the plate spring 114 has a resonant frequency which is a frequency f₁, a first AC signal that has the frequency f₁ is inputted to the plate spring control section 116.

The plate spring holding section 118 holds an end of the plate spring 114, and together with the plate spring control section 116, holds the plate spring 114. The fixed electrode 120 is arranged so as to be apart from the plate spring 114 and forms an electrostatic capacitance between the fixed electrode 120 and the plate spring 114. The fixed electrode 120 is fixed at a position regardless of vibration of the plate spring 114. The capacitive sensor 122 measures the electrostatic capacitance between the plate spring 114 and the fixed electrode 120, for example, by measuring electric charges that are accumulated in the fixed electrode 120.

It should be noted here that the plate spring 114 is vibrated by the plate spring control section 116 while the end of the plate spring 114 is held by the plate spring control section 116 and the plate spring holding section 118. Therefore, the vibration of the plate spring 114 causes periodic positional changes of a portion of the plate spring 114 in the vicinity of the center of the plate spring 114. This portion is directly held by neither the plate spring control section 116 nor the plate spring holding section 118. Thus, the vibration of the plate spring 114 periodically changes the distance between the plate spring 114 and the fixed electrode 120, which is arranged so as to be apart from the plate spring 114 and so as to be at a position where the fixed electrode 120 faces the plate spring 114.

As described above, the vibration of the plate spring 114 also causes periodic changes in magnitude of the electrostatic capacitance that is formed by the plate spring 114 and the fixed electrode 120. Therefore, it is possible to measure a vibration component of the plate spring 114 by measuring, with use of the capacitive sensor 122, the magnitude of the electrostatic capacitance that is formed by the plate spring 114 and the fixed electrode 120.

The capacitive sensor 122 calculates a vibration strength of the plate spring 114 for each vibration frequency of the plate spring 114, on the basis of the change in the electrostatic capacitance. Further, the capacitive sensor 122 outputs a signal in accordance with a detection result. In the present embodiment, the signal that is outputted by the capacitive sensor 122 is a signal obtained by replacing, with a signal strength for each frequency, the vibration strength of the plate spring 114 that is calculated, by the capacitive sensor 122, for each vibration frequency of the plate spring 114.

Except for the above, the vibration component measuring device 110 in accordance with the present embodiment has the same configuration as the vibration component measuring device 2, and carries out the same operation as the vibration component measuring device 2. Thus, in a first operation of the vibration component measuring device 110, the plate spring 114 vibrates at a vibration frequency f₁, and a second AC signal, which has a frequency 2f₁+fₘ, is applied between the plate spring 114 and the sample X. Accordingly, the capacitive sensor 122 outputs a signal that, like the signal shown in FIG. 2, has components at frequencies fi, f₁+fₘ, 2f₁+fₘ and 3f₁+fₘ.

A measurement signal which is outputted by the capacitive sensor 122 is inputted to a first phase locked loop circuit 20. The first phase locked loop circuit 20 thus outputs, from the measurement signal from the capacitive sensor 122, a comparison signal that includes a component of a frequency shift Δf of the vibration of the plate spring 114.

The comparison signal is inputted to the actual frequency lock-in amplifiers 42. The actual frequency lock-in amplifier 42 receives, as a reference signal, a reference AC signal from an AC power source 40. The actual frequency lock-in amplifier 42 thus outputs a signal which includes, as a varying component of the vibration of the plate spring 114 that is a vibration section, a modulated component Δf(fₘ) which is a component at a frequency fₘ among components of the frequency shift Δf.

The signal that includes the modulated component Δf(fₘ) and that is outputted by the actual frequency lock-in amplifier 42 to which the comparison signal is inputted is inputted to an analyzing section 44. The analyzing section 44 measures the modulated component Δf(fₘ). The analyzing section 44 then calculates, from the modulated component Δf(fₘ) that is measured for each voltage V_{dc}, an electric capacitance between an interface of the sample X and the plate spring 114. This calculation of the electric capacitance between the interface of the sample X and the plate spring 114 from the modulated component Δf(fₘ) can be carried out similarly to the calculation of the electric capacitance between the interface of the sample X and the cantilever probe 4 from the modulated component Δf(fₘ).

The vibration component measuring device 110 measures the modulated component Δf(fₘ), for example, while changing the value of the voltage V_{dc}. More specifically, the vibration component measuring device 110 measures respective modulated components Δf(fₘ) in cases where DC signals applied to the sample X are the first DC signal and the second DC signal which have respective different values of the voltage V_{dc}.

In a second operation of the vibration component measuring device 110 in accordance with the present embodiment, the first switch S1 is open and the second switch S2 is closed. Accordingly, a signal in which the reference AC signal having the frequency fₘ from the AC power source 40 and the DC signal having the having the voltage V_{dc} are superimposed on each other is applied to the sample X. Therefore, in the second operation of the vibration component measuring device 110, as in the first operation, a measurement signal which is outputted by the capacitive sensor 122 includes, in a side band at the frequency f₁+fₘ, a component of a frequency shift Δf.

Thus, in the second operation of the vibration component measuring device 110, as in the first operation, the actual frequency lock-in amplifier 42 outputs a signal which includes, as a varying component of the vibration of the plate spring 114 that is a vibration section, a modulated component Δf(fₘ), and inputs the signal to the analyzing section 44. As described above, the vibration component measuring device 110 measures a difference between the modulated components Δf(fₘ) that are obtained in the first operation and the second operation, respectively.

The vibration component measuring device 110 in accordance with the present embodiment, unlike the vibration component measuring device 2, can measure the modulated component Δf(fₘ), as the varying component of the vibration of the plate spring 114. In the present embodiment, as in the foregoing embodiment, the vibration component measuring device 110 can more efficiently measure a change in the varying component of the vibration section, and thus can more efficiently calculate the interface state density of the sample X.

In particular, the vibration component measuring device 110 in accordance with the present embodiment can measure the modulated component Δf(fₘ) from a measurement result of the capacitive sensor 122 that measures the capacitance between the plate spring 114 and the fixed electrode 120. In other words, the vibration component measuring device 110 does not require any capacitive sensor that has an expensive or complex configuration for directly measuring, for the modulated component Δf(fₘ), the capacitance between the sample X and the plate spring 114. Therefore, the vibration component measuring device 110 can more efficiently measure a change in the varying component of the vibration section than a device that includes a capacitive sensor for directly measuring capacitance between a sample X and a plate spring 114.

The vibration component measuring device 110 in accordance with the present embodiment can be used as an MEMS sensor that includes the micro-vibration detection mechanism 112 as a micro sensor. In the present embodiment, measurement of the vibration component of the plate spring 114 is carried out by measuring the capacitance between the plate spring 114 and the fixed electrode 120 with use of the fixed electrode 120 and the capacitive sensor 122. However, the measurement of the vibration component of the plate spring 114 is not limited to this configuration, but may be carried out with use of an optical fiber sensor.

Further, the plate spring 114 may include silicon that has a piezoresistive effect, crystal such as quartz that has a piezoelectric effect, or the like. In this case, the measurement of the vibration component of the plate spring 114 may be carried out by measuring a resistance value of the silicon that has a piezoresistive effect or by measuring electromotive force which occurs in the crystal that has a piezoelectric effect.

The above-described method for measuring the vibration component of the plate spring 114 differs from an optical lever method which employs the light source 16, the optical sensor 18, and the like. Therefore, it is not necessary, for example, to ensure an optical path from the light source 16 to the optical sensor 18. Accordingly, the above-described method of measuring the vibration component of the plate spring 114 makes it possible to further reduce a size of the vibration component measuring device 110.

The present disclosure is not limited to the embodiments, but can be altered variously by a person skilled in the art within the scope of the claims. The present disclosure also encompasses, in its technical scope, any embodiment derived by appropriately combining technical means disclosed in differing embodiments.

### REFERENCE SIGNS LIST

2 vibration component measuring device
4 cantilever probe
10 probe control section
20 first phase locked loop circuit
22 second phase locked loop circuit
36 multiplier
38 first amplitude modulator
40 AC power source
42 actual frequency lock-in amplifier
44 analyzing section
46 DC power source
48 adder
70 second amplitude modulator
74 double frequency lock-in amplifier
86 triple frequency lock-in amplifier
94 first lock-in amplifier
96 second lock-in amplifier
S1 first switch
S2 second switch

1. A vibration component measuring device comprising: a vibration section;
a first AC signal generator configured to generate a first AC signal;
a second AC signal generator configured to generate a second AC signal having a frequency which is higher than a frequency of the first AC signal and which differs from an integral multiple of the frequency of the first AC signal;
a reference AC signal generator configured to generate a reference AC signal having a frequency which is lower than the frequency of the first AC signal;
a DC signal generator configured to generate at least two DC signals including a first DC signal and a second DC signal having a voltage which is different from a voltage of the first DC signal;
a vibration control section configured to cause the vibration section to vibrate on the basis of the first AC signal;
a signal applying section configured to apply, between the vibration section and a sample, each of the DC signals and at least one selected from the group consisting of the second AC signal and the reference AC signal; and
a measuring section configured to measure a varying component of vibration of the vibration section, the varying component being varied by an interaction between the vibration section and the sample,
the measuring section measuring a change in the varying component relative to a change in voltage value between the first DC signal and the second DC signal, from the varying component in a case where the DC signal applied is set to the first DC signal and the varying component in a case where the DC signal applied is set to the second DC signal.

2. A vibration component measuring device comprising: a vibration section;
a first AC signal generator configured to generate a first AC signal;
a second AC signal generator configured to generate a second AC signal having a frequency which is higher than a frequency of the first AC signal and which differs from an integral multiple of the frequency of the first AC signal;
a reference AC signal generator configured to generate a reference AC signal having a frequency which is lower than the frequency of the first AC signal;
a DC signal generator configured to generate a DC signal;
a vibration control section configured to cause the vibration section to vibrate on the basis of the first AC signal;
a signal applying section configured to apply, between the vibration section and a sample, the DC signal and at least one selected from the group consisting of the second AC signal and the reference AC signal; and
a measuring section configured to measure a first derivative value, with respect to a voltage of the DC signal, of a varying component of vibration of the vibration section, the varying component being varied by an interaction between the vibration section and the sample.

3. A vibration component measuring device comprising: a vibration section;
a first AC signal generator configured to generate a first AC signal;
a second AC signal generator configured to generate a second AC signal having a frequency which is higher than a frequency of the first AC signal and which differs from an integral multiple of the frequency of the first AC signal;
a reference AC signal generator configured to generate a reference AC signal having a frequency which is lower than the frequency of the first AC signal;
a DC signal generator configured to generate a DC signal;
a vibration control section configured to cause the vibration section to vibrate on the basis of the first AC signal;
a signal applying section configured to apply, between the vibration section and a sample, the DC signal and at least one selected from the group consisting of the second AC signal and the reference AC signal; and
a measuring section configured to measure a second derivative value, with respect to a voltage of the DC signal, of a varying component of vibration of the vibration section, the varying component being varied by an interaction between the vibration section and the sample.

4. The vibration component measuring device as set forth in claim 2- or 3, wherein the measuring section further measures a change in the varying component relative to a change in voltage value of the DC signal.

5. The vibration component measuring device as set forth in claim 1, wherein the varying component includes a frequency shift of the vibration section.

6. The vibration component measuring device as set forth in claim 1, wherein the varying component includes an amplitude shift of the vibration section.

7. The vibration component measuring device as set forth in claim 1, wherein the varying component includes a phase shift of the vibration section.

8. The vibration component measuring device as set forth in claim 1, wherein the second AC signal has (a) a frequency obtained by adding the frequency of the reference AC signal to a frequency that is twice the frequency of the first AC signal or (b) a frequency obtained by subtracting the frequency of the reference AC signal from a frequency that is twice the frequency of the first AC signal.

9. The vibration component measuring device as set forth in claim 1, wherein:
the second AC signal has a first high frequency signal and a second high frequency signal; and
a difference between a frequency of the first high frequency signal and a frequency of the second high frequency signal is twice the frequency of the reference AC signal.

10. The vibration component measuring device as set forth in claim 9, wherein the first high frequency signal is in opposite phase from the second high frequency signal.

11. The vibration component measuring device as set forth in claim 1, wherein
the measuring section includes:
a measurement signal generator configured to detect a vibration component of the vibration section and generate a measurement signal on the basis of the vibration component; and
at least one lock-in amplifier configured to calculate the varying component by comparing, with a reference signal which is generated on the basis of the reference AC signal, a comparison signal which is generated on the basis of the measurement signal.

12. The vibration component measuring device as set forth in claim 11, wherein the at least one lock-in amplifier includes an actual frequency lock-in amplifier that calculates the varying component by comparing, with the comparison signal, an actual frequency reference signal having the same frequency as the reference AC signal.

13. The vibration component measuring device as set forth in claim 11, wherein the at least one lock-in amplifier includes a double frequency lock-in amplifier that calculates the varying component by comparing, with the comparison signal, a double frequency reference signal having a frequency which is twice the frequency of the reference AC signal.

14. The vibration component measuring device as set forth in claim 11, wherein the at least one lock-in amplifier includes a triple frequency lock-in amplifier that calculates the varying component by comparing, with the comparison signal, a triple frequency reference signal having a frequency which is three times the frequency of the reference AC signal.

15. The vibration component measuring device as set forth in claim 11, wherein:
the reference AC signal generator generates at least a first reference AC signal, and a second reference AC signal having a frequency that is different from the integral multiple of the frequency of the first AC signal; and
the at least one lock-in amplifier includes at least two lock-in amplifiers, and the at least two lock-in amplifiers include a first lock-in amplifier that calculates the varying component, by comparing, with the comparison signal, a first reference signal generated on the basis of the first reference AC signal, and a second lock-in amplifier that calculates the varying component by comparing, with the comparison signal, a second reference signal generated on the basis of the second reference AC signal.

16. A Kelvin probe force spectrometer comprising the vibration component measuring device recited in claim 1 in which the vibration section includes a cantilever.

17. A method for measuring a vibration component, comprising the steps of:
generating a first AC signal for causing a vibration section to vibrate;
generating a second AC signal having a frequency which is higher than a frequency of the first AC signal and which differs from an integral multiple of the frequency of the first AC signal;
generating a reference AC signal having a frequency which is lower than the frequency of the first AC signal;
generating at least two DC signals including a first DC signal and a second DC signal having a voltage which is different from a voltage of the first DC signal; and
measuring a varying component of vibration of the vibration section by applying, between the vibration section and a sample, each of the DC signals and at least one selected from the group consisting of the second AC signal and the reference AC signal and causing the vibration section to vibrate on the basis of the first AC signal, the varying component of the vibration of the vibration section being varied by an interaction between the vibration section and the sample,
in the step of measuring the varying component, a change in the varying component relative to a change in voltage value between the first DC signal and the second DC signal being measured from the varying component in a case where the DC signal applied is set to the first DC signal and the varying component in a case where the DC signal applied is set to the second DC signal.

18. A method for measuring a vibration component, comprising the steps of:
generating a first AC signal for causing a vibration section to vibrate;
generating a second AC signal having a frequency which is higher than a frequency of the first AC signal and which differs from an integral multiple of the frequency of the first AC signal;
generating a reference AC signal having a frequency which is lower than the frequency of the first AC signal;
generating a DC signal; and
measuring a first derivative value, with respect to a voltage of the DC signal, of a varying component of vibration of the vibration section by applying, between the vibration section and a sample, the DC signal and at least one selected from the group consisting of the second AC signal and the reference AC signal and causing the vibration section to vibrate on the basis of the first AC signal, the varying component of the vibration of the vibration section being varied by an interaction between the vibration section and the sample.

19. A method for measuring a vibration component, comprising the steps of:
generating a first AC signal for causing a vibration section to vibrate;
generating a second AC signal having a frequency which is higher than a frequency of the first AC signal and which differs from an integral multiple of the frequency of the first AC signal;
generating a reference AC signal having a frequency which is lower than the frequency of the first AC signal;
generating a DC signal; and
measuring a second derivative value, with respect to a voltage of the DC signal, of a varying component of vibration of the vibration section by applying, between the vibration section and a sample, the DC signal and at least one selected from the group consisting of the second AC signal and the reference AC signal and causing the vibration section to vibrate on the basis of the first AC signal, the varying component of the vibration of the vibration section being varied by an interaction between the vibration section and the sample.

20. A method for measuring, from a value measured by the method recited in claim 17, an interface state density at any of interfaces of the sample.
